(19) United States
(12) Patent Application Publication
(10) Pub. No.: US 2026/0254159 A1
(43) Pub. Date: Aug. 27, 2026

(54) SOCKET DEVICE

(71) Applicant: Anker Innovations Technology Co., Ltd., CHANGSHA (CN)

(72) Inventors: Xianjie TANG, SHENZHEN (CN); Xiang ZHANG, SHENZHEN (CN)

(21) Appl. No.: 19/540,810

(22) Filed: Feb. 16, 2026

(30) Foreign Application Priority Data
Feb. 24, 2025 (CN) 202520298889.X
May 27, 2025 (CN) 202521069679.X

(51) Int. Cl. H01R 13/62; H01R 13/24; H01R 13/514; H01R 13/627

(52) U.S. Cl. CPC H01R 13/6205; H01R 13/2442; H01R 13/514; H01R 13/6275

(57) ABSTRACT

A socket device includes a first socket module, a second socket module, and a connection member. A clamping space is defined between the second socket module and the first socket module, and the connection member is fixedly connected to the first socket module and movably connected to the second socket module, so that a relative position of the second socket module and the first socket module in a first direction is adjustable, and a size of the clamping space in the first direction is adjustable.

### CROSS-REFERENCE TO RELATED APPLICATIONS

The present application claims priorities to Chinese Patent Application No. 202520298889.X, entitled “SOCKET DEVICE”, filed on February 24, 2025, and Chinese Patent Application No. 202521069679.X, entitled “PLUG STRIP”, filed on May 27, 2025, both of which are herein incorporated by reference in their entirety.

### TECHNICAL FIELD

The present disclosure relates to the technical field of sockets, and in particular to a socket device.

### BACKGROUND

A socket is a receptacle into which one or more circuit wires can be inserted, allowing various connections to be made with other circuits. The socket is usually connected to a power source, and in a case where the socket is connected to a plug of an electrical device, electric current flows into the electrical device to meet its electricity needs. There are various types of sockets, and a socket device is a common type of socket widely used in a workplace, a study area, or other scenarios. At present, the socket device generally integrates one or more interfaces such as power, audio, video, USB (universal serial bus), etc., greatly improving a layout of an office desktop and user convenience.

In related art, the socket device is usually placed directly on a desktop, which is prone to displacement due to an external force. Additionally, the socket device is usually provided with multiple power supply interfaces. A planar layout of these power supply interfaces often results in a large overall size of the device, occupying excessive space and causing inconvenience in use.

### SUMMARY OF THE DISCLOSURE

The embodiments of the present disclosure provide a socket device. The socket device includes a first socket module, a second socket module, and a connection member. The second socket module is disposed opposite to the first socket module in a first direction. A clamping space is defined between the second socket module and the first socket module, and at least one selected from the group consisting of the first socket module and the second socket module is provided with a power supply interface. The connection member is fixedly connected to the first socket module and movably connected to the second socket module, so that a relative position of the second socket module and the first socket module in the first direction is adjustable, and a size of the clamping space in the first direction is adjustable.

### BRIEF DESCRIPTION OF THE DRAWINGS

In order to more clearly illustrate the technical solutions in some embodiments of the present disclosure or in the related art, hereinafter, the accompanying drawings that are used in the description of some embodiments or the related art will be briefly described. Obviously, the accompanying drawings in the description below are merely the accompanying drawings in some embodiments of the present disclosure. For those of ordinary skill in the art, other accompanying drawings may be obtained based on these accompanying drawings without any creative efforts.

FIG. 1 is a structural schematic view of a socket device in an embodiment of the present disclosure.

FIG. 2 is a top structural schematic view of the socket device of FIG. 1.

FIG. 3 is a cross-sectional structural schematic view of the socket device of FIG. 2 in an A-A direction.

FIG. 4 is a state schematic view illustrating the socket device assembled on a panel in an embodiment of the present disclosure.

FIG. 5 is a structural schematic view of the socket device of FIG. 1 from another perspective.

FIG. 6 is a structural schematic view illustrating assembly of a first anti-slipping member with a first socket module in an embodiment of the present disclosure.

FIG. 7 is a structural schematic view illustrating assembly of a second anti-slipping member with a second socket module in an embodiment of the present disclosure.

FIG. 8 is a structural schematic view illustrating assembly of the first socket module with the second socket module in an embodiment of the present disclosure.

FIG. 9 is an exploded structural schematic view of a structure of FIG. 8.

FIG. 10 is a structural schematic view of a first guiding part in an embodiment of the present disclosure.

FIG. 11 is a structural schematic view of the structure of FIG. 8 from another perspective.

FIG. 12 is a structural schematic view illustrating assembly of a decorative member with the first socket module in an embodiment of the present disclosure.

FIG. 13 is a structural schematic view of a connection member in an embodiment of the present disclosure.

FIG. 14 is a structural schematic view illustrating assembly of a pulling plate with the second socket module in an embodiment of the present disclosure.

FIG. 15 is a structural schematic view of a structure of FIG. 14 from another perspective.

FIG. 16 is another structural schematic view illustrating the assembly of the first socket module with the second socket module of the socket device in an embodiment of the present disclosure.

FIG. 17 is an exploded structural schematic view of a structure of FIG. 16.

FIG. 18 is a structural schematic view illustrating assembly of the pulling plate with the first socket module of FIG. 16.

FIG. 19 is an exploded structural schematic view of the connection member in an embodiment of the present disclosure.

FIG. 20 is a structural schematic view of an adjusting member in an embodiment of the present disclosure.

FIG. 21 is a cross-sectional structural schematic view illustrating assembly of the adjusting member with the second socket module in an embodiment of the present disclosure.

FIG. 22 is a structural schematic view of an adjusting member in another embodiment of the present disclosure.

FIG. 23 is an exploded structural schematic view of the adjusting member of FIG. 22.

FIG. 24 is a structural schematic view illustrating assembly of the adjusting member of FIG. 22 with the second socket module.

FIG. 25 is a cross-sectional structural schematic view of a structure of FIG. 24 in a C-C direction.

FIG. 26 is an enlarged structural schematic view of a part A of FIG. 25.

FIG. 27 is a cross-sectional structural schematic view of the adjusting member of FIG. 22.

FIG. 28 is a structural schematic view of a circuit board in an embodiment of the present disclosure.

FIG. 29 is a structural schematic view of a socket device in an embodiment of the present disclosure.

FIG. 30 is a top structural schematic view of the socket device of FIG. 29.

FIG. 31 is a cross-sectional structural schematic view of the socket device of FIG. 30 in a B-B direction.

FIG. 32 is a structural schematic view illustrating assembly of the connection member with the adjusting member of the socket device in an embodiment of the present disclosure.

FIG. 33 is an exploded structural schematic view of a structure of FIG. 32.

FIG. 34 is a structural schematic view of a socket device in an embodiment of the present disclosure.

FIG. 35 is a structural schematic view of the socket device of FIG. 34 from another perspective.

FIG. 36 is a side structural schematic view of the socket device.

FIG. 37 is a structural schematic view of the socket device in a collapsed state in an embodiment of the present disclosure.

FIG. 38 is an exploded structural schematic view illustrating a connection of the first socket module and the second socket module.

FIG. 39 is an exploded structural schematic view of the socket device.

FIG. 40 is a cross-sectional structural schematic view of the socket device of FIG. 36 in a A-A direction.

### DETAILED DESCRIPTION

In order to make purposes, technical solutions, and advantages of the present disclosure clearer and more understandable, further detailed explanation of the present disclosure is provided in conjunction with accompanying drawings and embodiments. It should be understood that specific embodiments described herein are only configured to explain the present disclosure and are not intended to limit the present disclosure.

Reference is now made to the accompanying drawings, which are not necessarily drawn to scale, for a detailed description of the specific technical solution. Similar or identical reference numerals may be configured to designate similar or identical parts in different accompanying drawings. The use of similar or identical reference numerals in different accompanying drawings does not mean that all accompanying drawings containing similar or identical reference numerals constitute a single or the same embodiment. The accompanying drawings illustrate, in a general manner and by way of example rather than limitation, various embodiments discussed in the present disclosure.

A desktop socket device has a socket device structure designed to be embedded in a conference table or an office desk, for providing connectivity to various networks or power sources, such as a computer network, a telephone network, or a power supply, etc. However, the desktop socket device in related art is generally fixed to the desktop by a screw or other means, resulting in a relatively cumbersome installation method that requires a tool for installation and is inconvenient to disassemble and assemble. Moreover, the desktop socket device in related art is only adapted to the desktop with one specific thickness. There is room for improvement in flexibility and convenience of installation and removal of the socket device.

Based on the above technical problems, the present disclosure provides a socket device with an improved structure, so as to facilitate assembly of the socket device on panels with different thicknesses and specifications, enabling quick and convenient installation and removal with better flexibility and convenience, thereby enhancing user experience.

Based on this, embodiments of the present disclosure provide the socket device, which can solve the problem that the socket device is directly placed on a desktop and is prone to displacement due to an external force, resulting in inconvenient use.

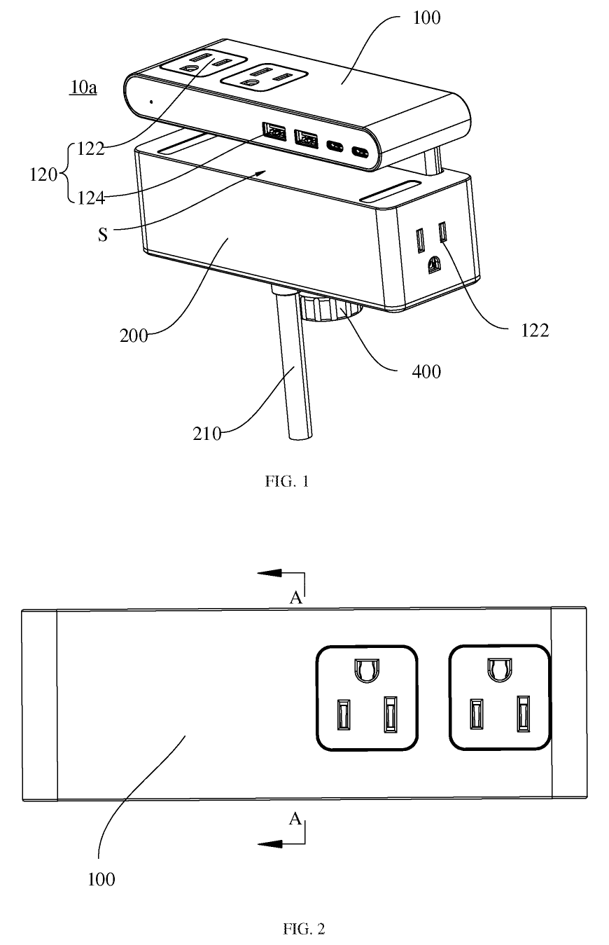

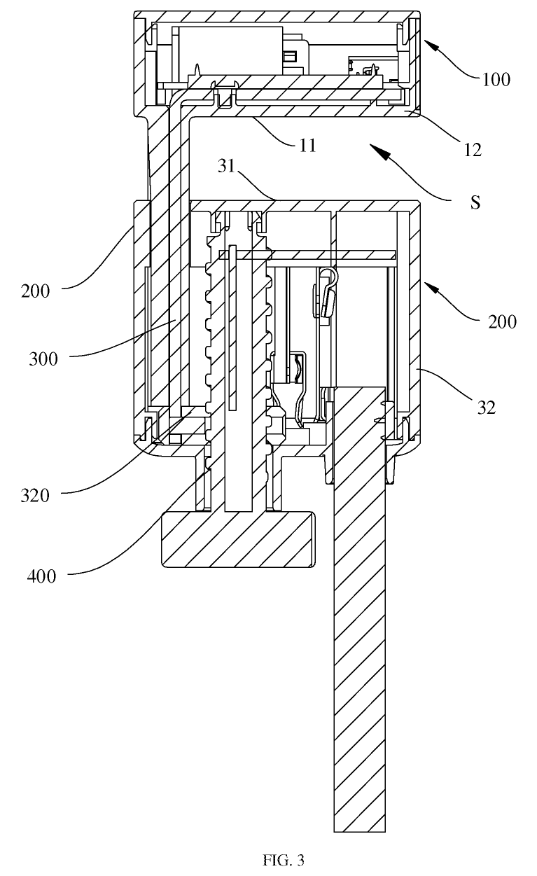

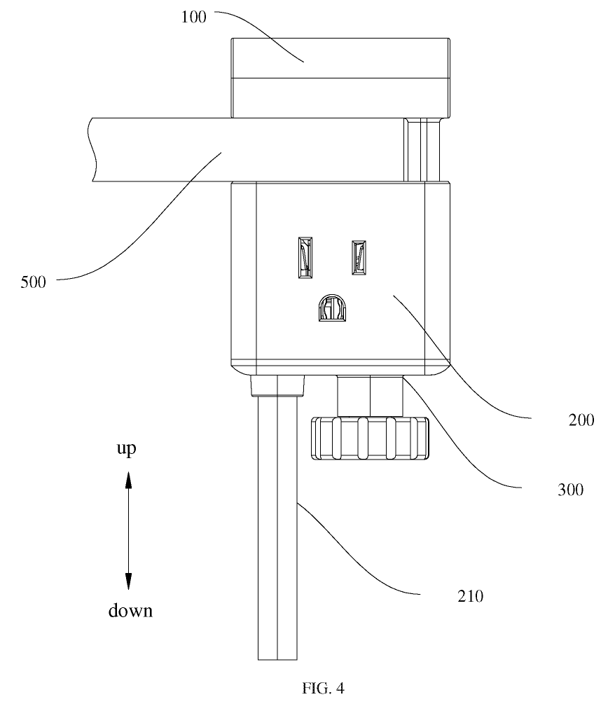

Based on the above design concept, the present disclosure provides a socket device 10a. FIG. 1 is a structural schematic view of the socket device 10a of the present disclosure, FIG. 2 is a top structural schematic view of the socket device 10a of FIGS. 1, and FIG. 3 is a cross-sectional structural schematic view of the socket device 10a of FIG. 2 in an A-A direction. Referring to FIG. 1 to 3, the socket device 10a includes a first socket module 100, a second socket module 200, and a connection member 300. The first socket module 100 and the second socket module 200 are disposed opposite to each other along a first direction, and at least one of the first socket module 100 and the second socket module 200 is provided with a power supply interface 120. A clamping space S is defined between the first socket module 100 and the second socket module 200. A panel 500 (as shown in FIG. 4), such as a desktop panel or other panels, may be disposed in the clamping space S between the first socket module 100 and the second socket module 200. FIG. 4 is a state schematic view illustrating the socket device 10a assembled on the panel 500. Referring to FIG. 4, in the socket device 10a in the present disclosure, since the first socket module 100 and the second socket module 200 are disposed opposite to each other in the first direction, a gap is defined between the first socket module 100 and the second socket module 200, so that the panel 500 such as the desktop panel or other panels may be disposed between the first socket module 100 and the second socket module 200. A surface of the first socket module 100 and a surface of the second socket module 200 are respectively in contact with surfaces of the panel 500, so that the socket device 10a clamps the panel 500. The connection member 300 is fixedly connected to the first socket module 100, and the connection member 300 is movably connected to the second socket module 200, so that a relative position of the first socket module 100 and the second socket module 200 in the first direction may be adjusted, thereby adjusting a size of the clamping space S in the first direction, and enabling the socket device 10a to clamp the panel 500 with different thicknesses.

The socket device 10 further includes an adjusting member 400, and the adjusting member 400 is rotatably connected to the second socket module 200. The adjusting member 400 avoids the clamping space S and is connected to the connection member 300. In a case where the adjusting member 400 rotates around its own axis, the adjusting member 400 and the connection member 300 move relative to each other, thereby driving the second socket module 200 and the first socket module 100 to move relative to each other in the first direction, and thus adjusting the size of the clamping space S in the first direction.

The connection member 300 is connected to the first socket module 100. The adjusting member 400 is rotatably connected to the second socket module 200, and the adjusting member 400 is connected to the connection member 300. Therefore, by rotating the adjusting member 400, the adjusting member 400 rotates around its own axis, so that the adjusting member 400 and the connection member 300 move relative to each other, thereby driving the second socket module 200 and the first socket module 100 to move relative to each other. That is, the second socket module 200 approaches or moves away from the first socket module 100, so that the size (a distance between the first socket module 100 and the second socket module 200) of the clamping space S between the first socket module 100 and the second socket module 200 can be adjusted, so as to enable the socket device 10a to be assembled on the panels 500 with different specifications and thicknesses. Since the distance between the first socket module 100 and the second socket module 200 may be adjusted by only rotating the adjusting member 400, the socket device 10a has good flexibility and convenience in disassembly and assembly, thereby improving user experience.

The specific details of the socket device 10a may be further described with reference to FIGS. 4 to 21.

Referring to FIG. 4, for convenience of description, the following description is made with the first socket module 100 disposed above the second socket module 200. In a case where the socket device 10a is assembled on the panel 500, the first socket module 100 is disposed on a top surface of the panel 500, and the second socket module 200 is disposed on a bottom surface of the panel 500. That is, the first direction is a vertical direction. In some embodiments, the first socket module 100 and the second socket module 200 may also be disposed obliquely to the vertical direction. In some embodiments, the second socket module 200 may be disposed above the first socket module 100. Corresponding arrangements may be made according to the content described in the present disclosure, which is not repeat in the present disclosure.

Both the first socket module 100 and the second socket module 200 include multiple power supply interfaces 120, and the multiple power supply interfaces 120 are respectively disposed on side surfaces of a first socket housing 12 and a second socket housing 32 in different directions. The multiple power supply interfaces 120 have the same or different types. On the one hand, providing more power supply docking units 120 can allow more electrical devices to be plugged in for power, thereby enhancing performance of the socket device 10a. On the other hand, adopting different types of power supply interfaces 120 can meet connection needs of the electrical devices with different plugs, expanding an application scope.

The power supply interface 120 may be, but is not limited to, at least one of a two-hole power supply interface, a three-hole power supply interface, a USB power supply interface, a Lighting power supply interface, or a Type-C power supply interface, etc.

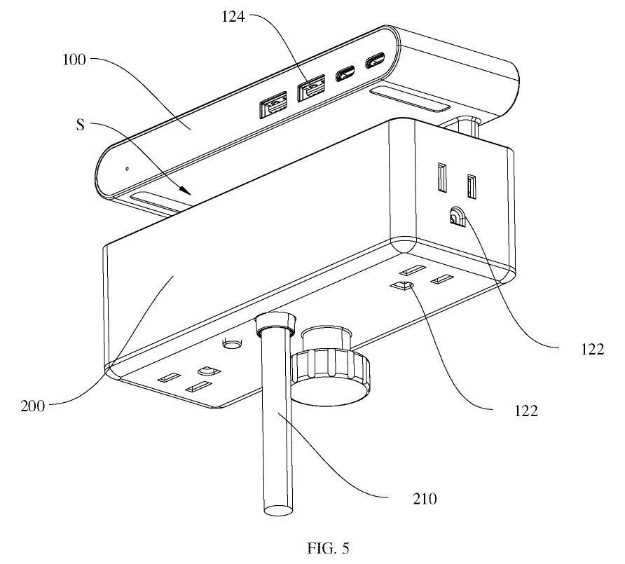

In some embodiments, since the first socket module 100 is disposed on the top surface of the panel 500, the first socket module 100 may be the DC power module commonly used in daily life. The power supply interface 120 of the first socket module 100 includes at least one of a three-pin socket 122, a two-pin socket (not shown in figures), or a charging interface 124. The charging interface 124 includes at least one of a USB interface, a Type-C interface, or a wireless charging interface (not shown in figures). In some embodiments, referring to FIG. 1, a top surface of the first socket module 100 is provided with the three-pin socket 122, and an inner side surface of the first socket module 100 is provided with the USB interface and the Type-C interface, so as to meet the power supply needs of different types of devices. Therefore, the socket device 10a has high integration. Since the second socket module 200 is disposed on the bottom surface of the panel 500, the second socket module 200 may be the AC power module that is less commonly used in daily life. In some embodiments, FIG. 5 is a structural schematic view of the socket device 10a of FIG. 1 from another perspective. Referring to FIG. 5, each of two ends of the second socket module 200 is provided with the three-pin socket 122, and a bottom surface of the second socket module 200 is also provided with the three-pin socket 122. In some embodiments, a power connector 210 of the socket device 10a further extends from the bottom surface of the second socket module 200, and a socket power cord 90 is configured to connect mains power to the socket device 10a. In some embodiments, socket forms of the first socket module 100 and the second socket module 200 of the socket device 10a may be correspondingly customized and adjusted according to user needs, so as to meet the needs of different types of customers. Therefore, the socket device 10a has good practicality.

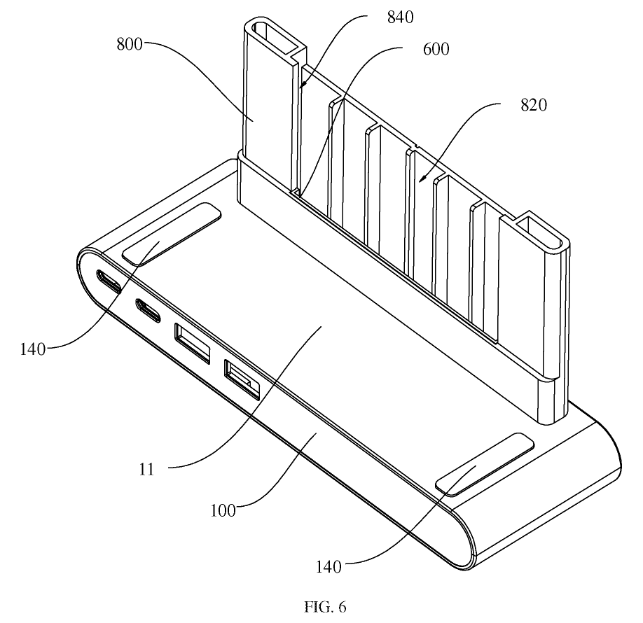

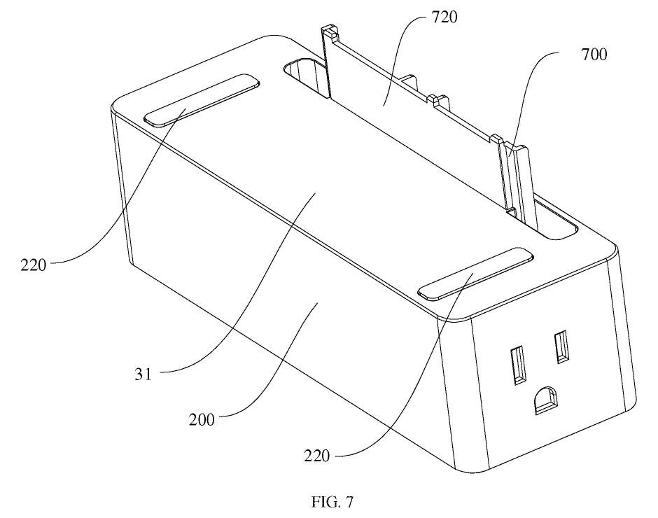

In an embodiment, as shown in FIG. 6, the first socket module 100 includes a first clamping surface 11 facing the second socket module 200, and as shown in FIG. 7, the second socket module 200 includes a second clamping surface 31 facing the first socket module 100. The first clamping surface 11 is spaced apart from the second clamping surface 31 to define the clamping space S. Therefore, the method and the structure of defining the clamping space S are simple. The first clamping surface 11 is in clamping contact with an upper surface of the desktop panel, and the second clamping surface 31 is in clamping contact with a lower surface of the desktop panel. The contact areas are large, which helps to improve stability of the socket device 10a installed on the desktop panel. Moreover, during installation, a width of the clamping space S is first widened, its opening is aligned with a side edge of the desktop panel, and then the socket device 10a is horizontally translated, so that the edge of the desktop panel can be inserted into the clamping space S. The assembly method is simple to operate.

In some embodiments, the first socket module 100 includes the first socket housing 12, and an end of the connection member 300 is fixedly connected to the first socket housing 12, so that the connection member 300 is able to move synchronously with the first socket module 100. The first socket housing 12 includes the first clamping surface 11. The second socket module 200 includes the second socket housing 32, and another end of the connection member 300 is movably assembled to the second socket housing 32, so that the relative position of the first socket module 100 and the second socket module 200 may be adjusted. The second socket housing 32 includes the second clamping surface 31.

In order to avoid loosening and displacement of the socket device 10a after installation, which would affect installation stability and safety in use, and in order to avoid damaging the desktop panel due to an excessive clamping force, the socket device 10a further includes a first anti-slipping member 140, and first anti-slipping member 140 is disposed on the first clamping surface 11; and/or, the socket device 10a further includes a second anti-slipping member 220, and the second anti-slipping member 220 is disposed on the second clamping surface 31.

FIG. 6 is a structural schematic view illustrating assembly of the first anti-slipping member 140 with the first socket module 100, and FIG. 7 is a structural schematic view illustrating assembly of the second anti-slipping member 220 with the second socket module 200. Both a side surface of the first anti-slipping member 140 facing the panel 500 and a side surface of the second anti-slipping member 220 facing the panel 500 may be provided with textures. In a case where the socket device 10a is assembled onto the panel 500, a friction coefficient between the first anti-slipping member 140 and the panel 500 increases, and a friction coefficient between the second anti-slipping member 220 and the panel 500 increases, so as to prevent the first socket module 100 and the second socket module 200 from moving relative to the panel 500, thereby improving firmness of the socket device 10a assembled onto the panel 500.

In some embodiments, two or more first anti-slipping members 140 may be disposed at intervals along a length direction of the first socket module 100 and disposed on the bottom surface of the first socket module 100. The first anti-slipping members 140 may be gaskets. The first anti-slipping members 140 may be embedded or adhered to the bottom surface of the first socket module 100. Two or more second anti-slipping members 220 may be disposed at intervals along a length direction of the second socket module 200 and disposed on the top surface of the second socket module 200. The second anti-slipping members 220 may also be the gaskets. The second anti-slipping members 220 may be embedded or adhered to the top surface of the second socket module 200. In some embodiments, the first anti-slipping member 140 may extend along the length direction of the first socket module 100 and be disposed on the bottom surface of the first socket module 100, and the second anti-slipping member 220 may extend along the length direction of the second socket module 200 and disposed on the top surface of the second socket module 200, which is not limited in the present disclosure.

In some embodiments, the socket device 10a may include both the first anti-slipping member 140 and the second anti-slipping member 220. In some embodiments, the socket device 10a may only include one of the first anti-slipping member 140 and the second anti-slipping member 220, which is not limited in the present disclosure.

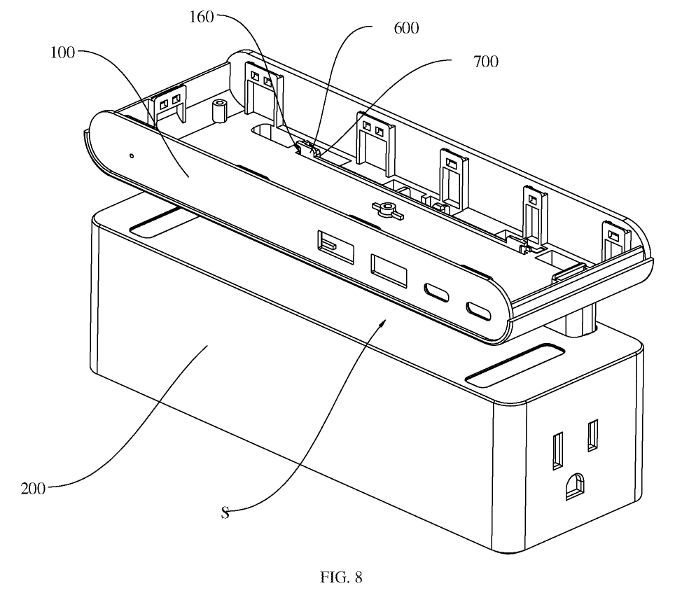

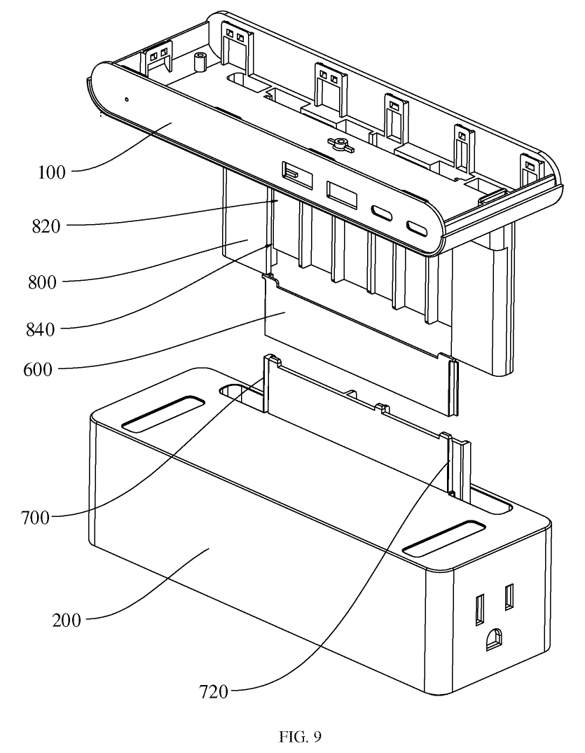

FIG. 8 is a structural schematic view illustrating assembly of the first socket module with the second socket module, and FIG. 9 is an exploded structural schematic view of a structure of FIG. 8. For clarity, an upper cover part of the first socket module 100 and a bottom cover part of the second socket module 200 are omitted in FIGS. 8 and 9. Referring to FIGS. 6 to 9, since the second socket module 200 is able to approach or move away from the first socket module 100, in order to allow the second socket module 200 to move relative to the first socket module 100 in a predetermined direction, the socket device 10 of the present disclosure may further include a first guiding part 600 and a second guiding part 700. The first guiding part 600 is connected to the first socket module 100, the second guiding part 700 is connected to the second socket module 200, and the second guiding part 700 is connected to the first guiding part 600 via an insertion engagement. Under the adjustment of the second socket module 200 approaching or moving away from the first socket module 100, the second guiding part 700 also reciprocates synchronously within the first guiding part 600, thereby providing guidance for a moving direction of the second socket module 200 relative to the first socket module 100, so that the second socket module 200 is able to move relative to the first socket module 100 in the predetermined direction (the first direction).

FIG. 10 is a structural schematic view of the first guiding part 600. Referring to FIGS. 9 and 10, in some embodiments, the first guiding part 600 is connected to a side surface of the first socket module 100 facing the second socket module 200, that is, the first guiding part 600 is connected to the first clamping surface 11. The first guiding part 600 defines a first guiding groove 620 that is a through groove extending in the vertical direction, and an opening of the first guiding groove 620 faces a horizontal direction (e.g., towards the guiding protrusion 720 for assembly). The second guiding part 700 is connected to a side surface of the second socket module 200 facing the first socket module 100, that is, the second guiding part 700 is connected to the second clamping surface 31 of the second socket module 200. The second guiding part 700 is provided with a guiding protrusion 720. The guiding protrusion 720 is assembled into the first guiding groove 620 from an opening side of the first guiding groove 620, and the guiding protrusion 720 reciprocates vertically within the first guiding groove 620, so as to restrict the moving direction of the second socket module 200.

Referring to FIG. 8 to10, in some embodiments, the first guiding part 600 is snap-fitted to the first socket module 100. In some embodiments, the first guiding part 600 has a plate-shaped structure, and a connection protrusion 640 is disposed on each of two sides of a top end of the first guiding part 600. The bottom surface of the first socket module 100 defines an assembly hole 160, and the top end of the first guiding part 600 passes through the assembly hole 160. The connection protrusion 640 is hung or hooked on an inner side of the bottom surface of the first socket module 100. In some embodiments, the first guiding part 600 may also be integrated with the first socket module 100.

In some embodiments, the second guiding part 700 may be integrated with the second socket module 200. The specific assembly method of the second guiding part 700 and the second socket module 200 may refer to the relevant description above, which is not repeated in the present disclosure.

In some embodiments, the second guiding part 700 defines the first guiding groove 620, and the first guiding part 600 is provided with the guiding protrusion 720 that reciprocates within the first guiding groove 620, thereby limiting the moving direction of the second socket module 200, which is not repeated in the present disclosure.

Referring to FIGS. 6 to 10, the socket device 10 further includes a decorative member 800, and the decorative member 800 is connected to one of the first socket module 100 and the second socket module 200. The decorative member 800 defines a decorative chamber 820. At least a part of the first guiding part 600, at least a part of the second guiding part 700, and a part of the connection member 300 disposed between the first socket module 100 and the second socket module 200 are all disposed in the decorative chamber 820. In this way, during the movement of the second socket module 200 relative to the first socket module 100, the first guiding part 600 and the second guiding part 700 move in the decorative chamber 820. Moreover, since the part of the connection member 300 disposed between the first socket module 100 and the second socket module 200 is also disposed in the decorative chamber 820, the above-mentioned components may be hidden by the decorative member 800, thereby achieving a neat and beautiful appearance of a product.

In some embodiments, the decorative member 800 is connected to the bottom surface of the first socket module 100. In some embodiments, the decorative member 800 has a plate-shaped structure with an elliptical cross-section, and the decorative member 800 is integrated with the first socket module 100.

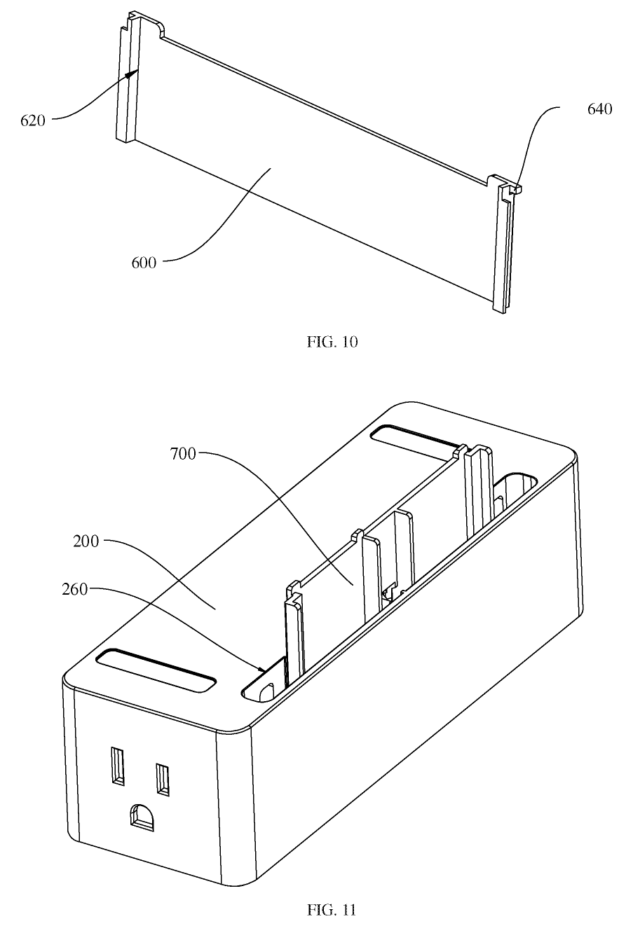

FIG. 11 is a structural schematic view of the structure of FIG. 8 from another perspective. Referring to FIG. 11, the top surface of the second socket module 200 defines a decorative groove 260, and at least a part of the decorative member 800 is movably disposed in the decorative groove 260. In this way, during the movement of the second socket module 200 relative to the first socket module 100, the decorative member 800 may completely fill the space between the first socket module 100 and the second socket module 200 through the movement of the decorative member 800 in the decorative groove 260, thereby ensuring the neat and beautiful appearance of the product. In addition, the decorative member 800 may also be configured to achieve centering between the first socket module 100 and the second socket module 200, facilitating the assembly of the socket device 10a onto the panel 500. In some embodiments, the decorative member 800 may also be connected to the top surface of the second socket module 200, and the bottom surface of the first socket module 100 defines the decorative groove 260, which can also allow the decorative member 800 to fill the space between the first socket module 100 and the second socket module 200, thereby ensuring the neat and beautiful appearance of the product.

Referring to FIG. 11, the decorative groove 260 and the assembly hole 160 are defined opposite to each other. The guiding protrusion 720 of the second guiding part 700 is integrated with a side wall of the decorative groove 260. A gap is defined between the second guiding part 700 and another side wall of the decorative groove 260, so that the connection member 300 is able to enter the second socket module 200 through the gap.

In some embodiments, the second guiding part 700 is able to be movably inserted into the decorative chamber 820 of the decorative member 800 and disposed on an inner wall of the decorative member 800, so as to guide the movement of the second guiding part 700, thereby causing the second socket module 200 to move in the predetermined direction. FIG. 12 is a structural schematic view illustrating assembly of the decorative member 800 with the first socket module 100. Referring to FIG. 12, the inner wall of decorative member 800 defines a second guiding groove 840, and the second guiding groove 840 is a through groove and extends in a direction from the first socket module 100 to the second socket module 200. That is, the second guiding groove 840 vertically extends, and at least a part of the second guiding part 700 is correspondingly disposed in the second guiding groove 840. In this way, the moving direction of the second guiding part 700 may be restricted by the second guiding groove 840, thereby ensuring that the second socket module 200 moves in the predetermined direction.

Referring to FIG. 12, the second guiding groove 840 opens towards the panel 500, that is, an outer side of the decorative member 800 is closed, while an inner side of the decorative member 800 defines an opening. The second guiding part 700 is connected to a side of the decorative groove 260 facing the panel 500. The second guiding part 700 is disposed between the first guiding part 600 and an opening side of the second guiding groove 840, so that the second guiding part 700 is able to reciprocate between the first guiding part 600 and the opening side of the second guiding groove 840. This setting not only ensures the neat and beautiful appearance of the product, but also makes the structure of the product compact, thereby improving the firmness of the socket device 10a assembled onto the panel 500.

The first guiding part 600 and the decorative member 800 of the present disclosure are connected to an outer side of the bottom surface of the first socket module 100, and the second guiding part 700 is connected to an outer side of the top surface of the second socket module 200. In this way, in a case where the socket device 10a is assembled on the panel 500, a size of the socket device 10a protruding from the panel 500 may be minimized as much as possible. On the one hand, it can ensure the neatness of the panel 500, and on the other hand, it can also prevent the user’s clothing and other items from hanging or snagging on the socket device 10a to a certain extent, thereby improving the user experience.

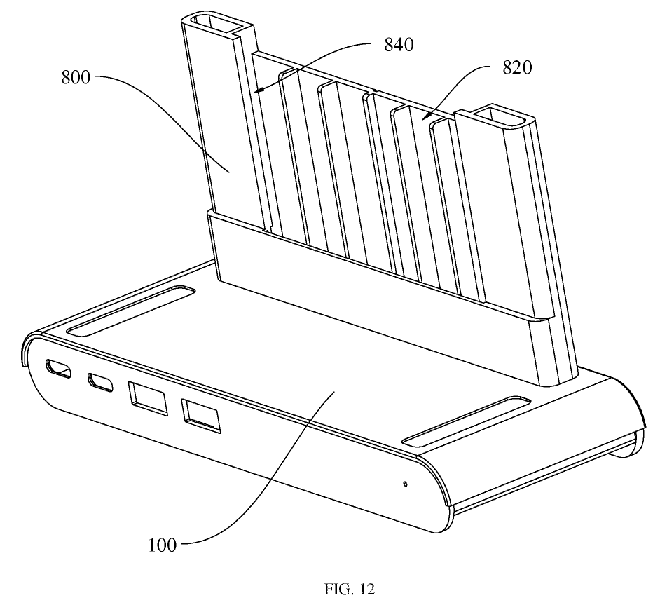

FIG. 13 is a structural schematic view of the connection member 300. Referring to FIG. 13, the connection member 300 includes a pulling plate 340 and a support part 320. An end of the pulling plate 340 is connected to the first socket module 100, and another end of the pulling plate 340 extends towards the second socket module 200. The support part 320 is connected to another end of the pulling plate 340. In some embodiments, the pulling plate 340 includes a connection section 342 and a joining section 344. The connection section 342 may be integrated with the joining section 344, or the connection section 342 is connected to the joining section 344 by means such as snap-fitting. The connection section 342 extends horizontally inside the first socket module 100. The connection section 342 is connected to the bottom surface of the first socket module 100 through screws and other components, thereby achieving assembly of the connection section 342 with the first socket module 100. The joining section 344 passes through the first socket module 100 in the vertical direction and extends into the second socket module 200, so that the pulling plate 340 has an L-shaped structure. The support part 320 is connected to an end of the joining section 344 away from the connection section 342.

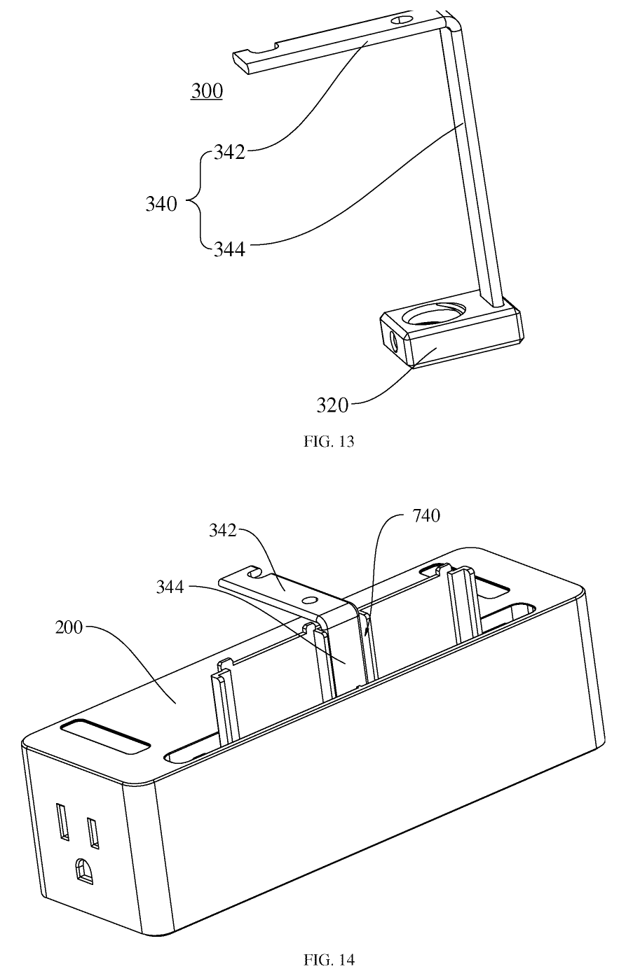

FIG. 14 is a structural schematic view illustrating assembly of the pulling plate 340 with the second socket module 200. Referring to FIG. 14, the second guiding part 700 defines a first limit groove 740, and an opening side of the first limit groove 740 faces away from the first guiding part 600. The joining section 344 is fittingly or adaptively inserted into the first limit groove 740, so as to restrict the extending direction of the joining section 344, and the connection section 342 may be fixedly assembled on the bottom surface of the first socket module 100 using fewer screws or other components, thereby facilitating the assembly of the product.

Referring to FIG. 14, another end of the pulling plate 340 extends into the second socket module 200, so that the support part 320 and at least a part of the adjusting member 400 connected to the support part 320 are disposed inside the second socket module 200, thereby hiding the support part 320 and the adjusting member 400 through the second socket module 200, thus improving the aesthetic appearance of the product.

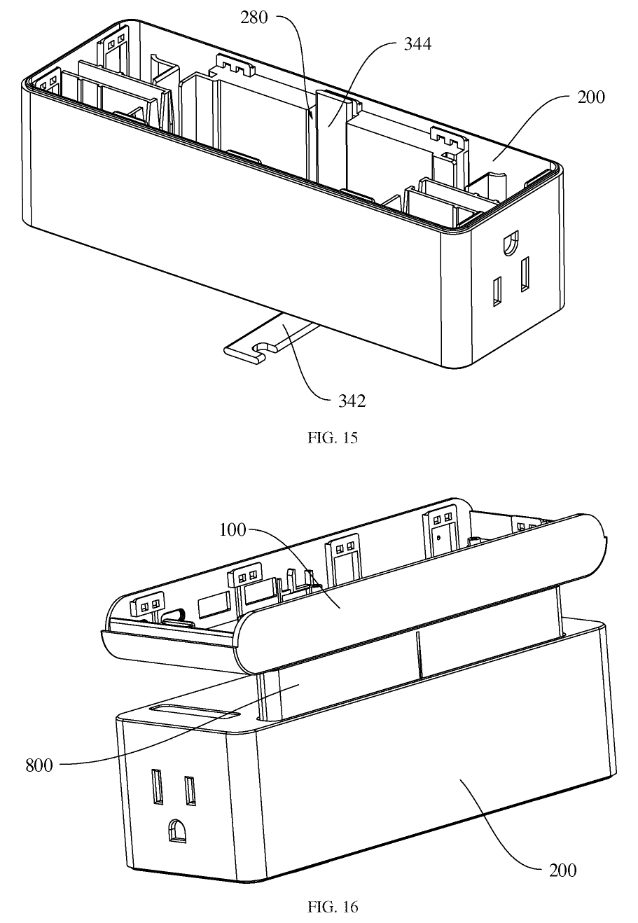

FIG. 15 is a structural schematic view of a structure of FIG. 14 from another perspective. Referring to FIG. 15, a second limit groove 280 is defined on the inner wall of the second socket module 200. An opening side of the second limit groove 280 faces the first guiding part 600, and the opening directions of the first limit groove 740 and the second limit groove 280 are opposite. The joining section 344 is adaptively inserted into the second limit groove 280, so as to restrict the extending direction of the joining section 344, thereby facilitating the assembly of the product.

Both the first limit groove 740 and the second limit groove 280 of the present disclosure may be defined, or only the first limit groove 740 may be defined, or only the second limit groove 280 may be defined, which may restrict the extending direction of the joining section 344, thereby facilitating the assembly of the product. In addition, at least a part of the first guiding part 600 and at least a part of the second guiding part 700 are disposed in the decorative chamber 820, which means that both the first guiding part 600 and the second guiding part 700 may be disposed in the decorative chamber 820, or a part of the first guiding part 600 and a part of the second guiding part 700 may be disposed in the decorative chamber 820, depending on a length of the decorative member 800.

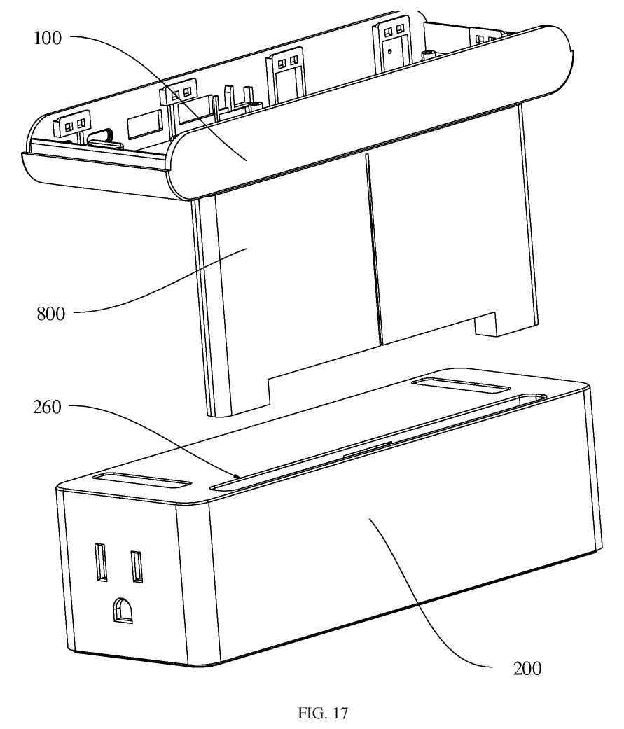

FIG. 16 is another structural schematic view illustrating the assembly of the first socket module 100 with the second socket module 200 of the socket device, and FIG. 17 is an exploded structural schematic view of a structure of FIG. 16. Referring to FIG. 16 and 17, in some embodiments, the first guiding part 600 and the second guiding part 700 of the socket device 10a may be omitted, and the decorative member 800 is adaptively inserted into the decorative groove 260. Through the reciprocating movement of the decorative member 800 in the decorative groove 260, the movement of the second socket module 200 relative to the first socket module 100 is guided, and the centering between the first socket module 100 and the second socket module 200 may be achieved, which facilitates the assembly of the first socket module 100 with the second socket module 200.

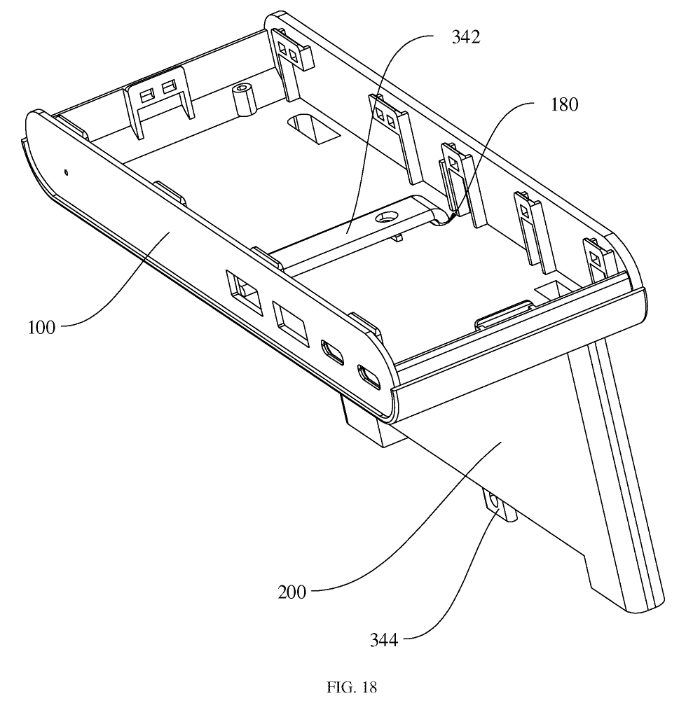

FIG. 18 is a structural schematic view illustrating assembly of the pulling plate 340 with the first socket module 100 of FIG. 16. Referring to FIG. 18, the bottom surface of the first socket module 100 defines a penetrating hole 180. The joining section 344 of the pulling plate 340 adaptively pass through the penetrating hole 180 and the decorative member 800, and enter the second socket module 200. The penetrating hole 180 may also limit the extending direction of the joining section 344 and fix the connection section 342 on the bottom surface of the first socket module 100 using fewer screws or other components, thereby facilitating the assembly of the product.

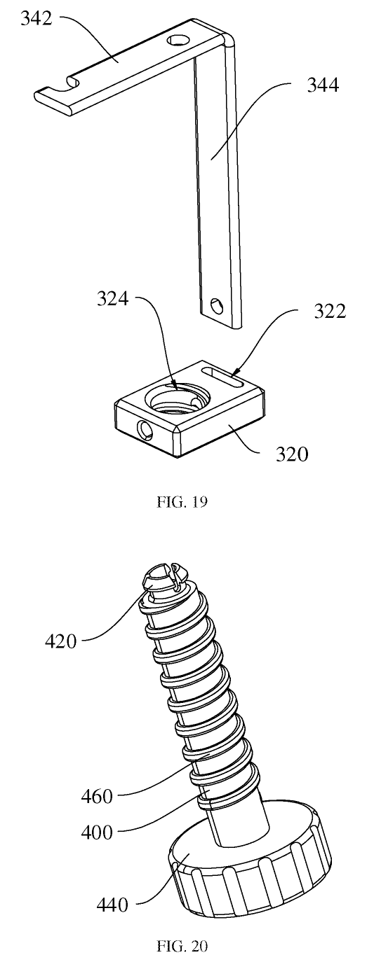

FIG. 19 is an exploded structural schematic view of the connection member 300. Referring to FIG. 19, in some embodiments, the support part 320 of the connection member 300 is disposed on the outer side of the first socket module 100 and on the side of the first socket module 100 facing the second socket module 200. That is, the support part 320 is spaced apart from the first socket module 100, and the adjusting member 400 passes through the support part 320 via a threaded engagement. The rotatable adjusting member 400 is able to move relative to the support part 320 and the first socket module 100, thereby driving the second socket module 200 to approach or move away from the first socket module 100. Therefore, the size (the distance between the first socket module 100 and the second socket module 200) of the clamping space S between the first socket module 100 and the second socket module 200 may be adjusted, thereby enabling the socket device 10a to be assembled on the panels 500 with different specifications and thicknesses.

Referring to FIG. 19, the support part 320 serves as a carrier for rotation of the adjusting member 400. The support part 320 defines a connection hole 322, and the joining section 344 is inserted into the connection hole 322. The joining section 344 is assembled and connected to the support part 320 through the screws or other components, so that the support part 320 and the pulling plate 340 are fixed, and thus the support part 320 is also fixed with respect to the first socket module 100. In some embodiments, the support part 320 may also be integrated with the joining section 344, which is not limited in the present disclosure.

In some embodiments, the support part 320 may be disposed horizontally in the second socket module 200, so that the support part 320 is disposed opposite to the first socket module 100. The second socket module 200 is able to move relative to the first socket module 100, and the connection member 300 is connected to the first socket module 100, that is, the connection member 300 is fixed relative to the first socket module 100. Therefore, the second socket module 200 is able to move relative to the support part 320 of the connection member 300. In some embodiments, the support part 320 may also have a certain inclination angle, so that the support part 320 is disposed obliquely inside the second socket module 200.

Referring to FIG. 19, the support part 320 defines a threaded hole 324, and the threaded hole 324 is a through hole that extends vertically. The adjusting member 400 is connected to the threaded hole 324 via the threaded engagement. In a case where the adjusting member 400 is rotated, the adjusting member 400 is able to rotate in the threaded hole 324 and move relative to the supporting part 320. In a case where rotation of the adjusting member 400 is stopped, due to a self-locking function of the thread, the adjusting member 400 is able to be fixed relative to the threaded hole 324. Due to the support part 320 being disposed horizontally in the second socket module 200, the adjusting member 400 moves vertically relative to the support part 320, that is, the adjusting member 400 is able to perform a lifting and lowering movement.

FIG. 20 is a structural schematic view of the adjusting member 400. Referring to FIG. 20, the adjusting member 400 has a rod-shaped structure, and at least a part of a peripheral surface of the adjusting member 400 has threads 460, so that the adjusting member 400 is connected to the threaded hole 324 of the support part 320 via the threaded engagement.

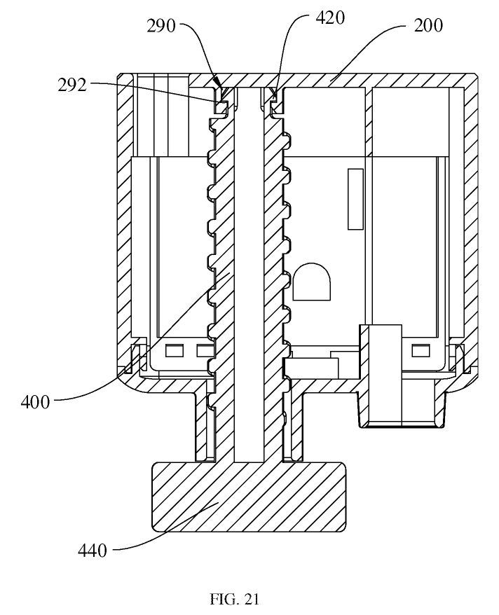

FIG. 21 is a cross-sectional structural schematic view illustrating assembly of the adjusting member 400 with the second socket module 200. Referring to FIGS. 20 and 21, the second socket module 200 defines a snap-fit groove 290, and a head part (i.e., a first end of the adjusting member 400) of the adjusting member 400 is rotatably clamped in the snap-fit groove 290. In a case where the adjusting member 400 is rotated, the head part of the adjusting member 400 rotates in the groove 290, and at the same time, the adjusting member 400 drives the second socket module 200 to move up and down synchronously, thereby driving the second socket module 200 to approach or move away from the first socket module 100. In order to assemble the socket device 10 onto the panel 500, the first socket module 100 is first disposed on the top surface of the panel 500, and the decorative member 800 is configured to position the second socket module 200 in a suitable position below the panel 500. The adjusting member 400 is then rotated, so that the adjusting member 400 drives the second socket module 200 to move towards the first socket module 100. That is, the second socket module 200 moves upward until the second socket module 200 abuts against the bottom surface of the panel 500. The rotation of the adjusting member 400 is stopped, and the socket device 10a may be assembled onto the panel 500. In a case where the socket device 10 is disassembled, reverse operations are performed, which is not repeated in the present disclosure.

Referring to FIGS. 20 and 21, the snap-fit groove 290 is defined on the inner side of the top surface of the second socket module 200. An inner wall of the snap-fit groove 290 is provided with multiple support protrusions 292, and the support protrusions 292 are spaced apart around the periphery of the snap-fit groove 290. The head part of the adjusting member 400 is provided with multiple engagement protrusions 420, and the engagement protrusions 420 are spaced apart, so that the engagement protrusions 420 may be gathered together under an external force. The head part of the adjusting member 400 is able to movably pass through the support protrusions 292, and the engagement protrusions 420 are disposed on or engaged with the support protrusions 292, enabling the head part of the adjusting member 400 to rotate in the snap-fit groove 290 without detaching or disengaging from the snap-fit groove 290.

Referring to FIGS. 20 and 21, a tail part (i.e. a second end of the adjusting member 400) of the adjusting member 400 may movably pass through the second socket module 200, so that the tail part of the adjusting member 400 is disposed outside the second socket module 200, facilitating operation of the adjusting member 400 by the user.

Referring to FIGS. 20 and 21, in some embodiments, the tail part of the adjusting member 400 movably passes through the side of the second socket module 200 away from the first socket module 100. That is, the tail part of the adjusting member 400 is disposed below the bottom of the second socket module 200. The tail part of the adjusting member 400 is provided with an operation part 440, and the operation part 440 is disposed on the side of the second socket module 200 away from the first socket module 100. That is, the operation part 440 is disposed on the outer side of the bottom surface of the second socket module 200. The operation part 440 may be a nut, allowing the user to conveniently grip the operation part 440 to operate the adjusting member 400.

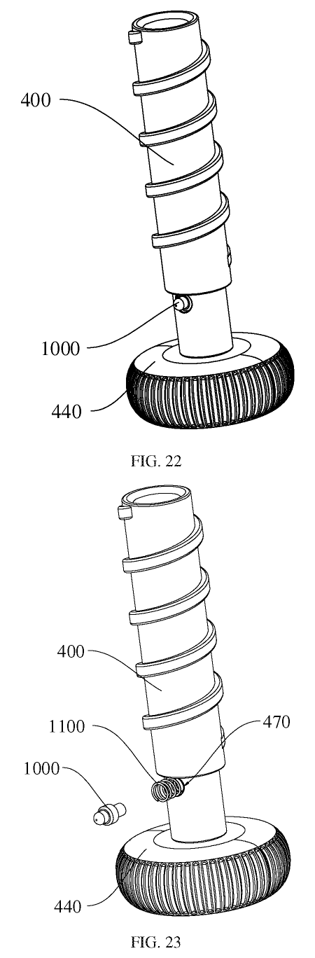

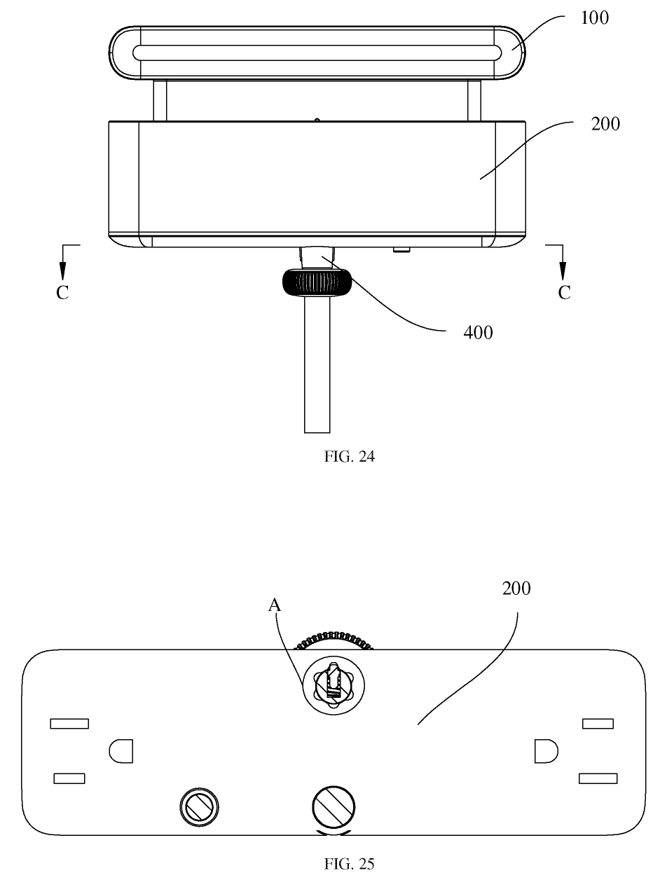

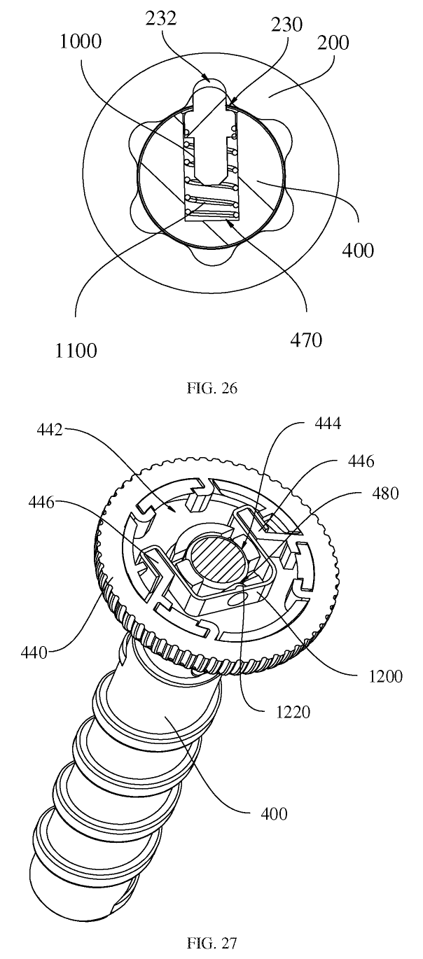

FIG. 22 is a structural schematic view of the adjusting member 400, FIG. 23 is an exploded structural schematic view of the adjusting member 400, FIG. 24 is a structural schematic view illustrating assembly of the adjusting member 400 of FIG. 22 with the second socket module 200, FIG. 25 is a cross-sectional structural schematic view of a structure of FIG. 24 in a C-C direction, and FIG. 26 is an enlarged structural schematic view of a part A of FIG. 25. Referring to FIG. 22 to 26, in some embodiments, the second socket module 200 defines a through hole 230. In some embodiments, the through hole 230 is defined on the bottom of the second socket module 200, and a side wall of the through hole 230 defines multiple first positioning grooves 232 that are spaced apart, and the first positioning grooves 232 are disposed circumferentially around the through hole 230. The adjusting member 400 movably passes through the through hole 230, and a first connection groove 470 is defined on the peripheral surface of the adjusting member 400. The socket device 10a further includes a positioning member 1000 and a first elastic element 1100. The positioning member 1000 has a first end and a second end, and the first end of the positioning member 1000 is movably disposed in the first connection groove 470. The second end of the positioning member 1000 is able to movably and telescopically pass through the first connection groove 470, and the first elastic element 1100 may be a spring. The first elastic element 1100 is disposed in the first connection groove 470 and connected between the first end of the positioning member 1000 and the inner wall of the first connection groove 470.

In a case where the user does not operate the adjusting member 400, the first elastic element 1100 supports the positioning member 1000, so that the second end of the positioning member 1000 passes through the opening side of the first connection groove 470 to penetrate the peripheral surface of the adjusting member 400 and move into the first positioning groove 232. In a case where the user operates the adjusting member 400 and the adjusting member 400 is rotated, the adjusting member 400 drives the positioning member 1000 to rotate synchronously. The second end of the positioning member 1000 is pressed by the side wall of the first positioning groove 232, and the second end of the positioning member 1000 moves into the first connection groove 470 through the opening side of the first connection groove 470, while compressing the first elastic element 1100. The user continues to rotate the adjusting member 400. In a case where the opening side of the first connection groove 470 is opposite to the opening side of another first positioning groove 232, under the reset drive of the first elastic element 1100, the second end of the positioning member 1000 passes through the opening side of the first connection groove 470 and penetrates the peripheral surface of the adjusting member 400 again, and moves into another first positioning groove 232. In this way, the positioning member 1000 may expand and contract multiple times with the rotation of the adjusting member 400. In a case where the second end of the positioning member 1000 moves into the first positioning groove 232, the second end of the positioning member 1000 may hit the groove wall of the first positioning groove 232, producing a clicking sound. It may create a damping sensation during the rotation of the adjusting member 400, improving the tactile feel for the user during operating the adjusting member 400, which has good practicality.

Referring to FIG. 26, the positioning member 1000 may have the rod-shaped structure, and the middle of the peripheral surface of the positioning member 1000 protrudes relative to two ends of the positioning member 1000. The first elastic element 1100 is sleeved on the first end of the positioning member 1000 and disposed between the middle of the positioning member 1000 and the bottom of the first positioning groove 232. The second end of the positioning member 1000 is configured in a spherical shape, so that the second end of the positioning member 1000 is able to be smoothly pressed by the side wall of the first positioning groove 232, driving the second end of the positioning member 1000 to move toward the first connection groove 470.

The multiple first positioning grooves 232 of the present disclosure are disposed at equal intervals around the circumference of the through hole 230, and a size of the first positioning grooves 232 along an opening direction of the through hole 230 needs to be greater than the stepping stroke of the adjusting member 400, so as to prevent formation of the first positioning grooves 232 from limiting the stepping movement of the adjusting member 400.

FIG. 27 is a cross-sectional structural schematic view of the adjusting member of FIG. 22. In some embodiments, the socket device 10a further includes a second elastic element 1200. One of the second end of the adjusting member 400 and the operation part 440 defines a second connection groove 480, and the second elastic element 1200 is connected to the other of the second end of the adjusting member 400 and the operation part 440. The second elastic element 1200 is able to be inserted into the second connection groove 480, and the second elastic element 1200 is able to be separated from the second connection groove 480. That is, by setting the second elastic element 1200, the operation part 440 is able to be connected to or separated from the second end of the adjusting member 400. During the user rotating the operation part 440, the second elastic element 1200 is connected to the second end of the adjusting member 400 and the operation part 440. The operation part 440 and the second end of the adjusting member 400 rotate synchronously, so as to drive the second socket module 200 to move toward the first socket module 100. In a case where the second socket module 200 moves to the bottom of the panel 500, the second end of the adjusting member 400 cannot continue to rotate. At this time, in a case where the user continues to rotate the operation part 440, the second elastic element 1200 may detach or disengage from the second connection groove 480, separating the operation part 440 from the second end of the adjusting member 400. The rotation of the operation part 440 cannot drive the adjusting member 400 to continue rotating. This setting can avoid damaging the product caused by continuing to rotate the adjusting member 400 during the adjusting member 400 being in a fixed state, which has good practicality.

Referring to FIG. 27, in some embodiments, the operation part 440 defines a receiving chamber 442, and an installation hole 444 is defined on a side surface of the operation part 440. The second end of the adjusting member 400 movably passes through the installation hole 444 and is disposed in the receiving chamber 442. The second connection groove 480 is opened or defined on the peripheral surface of the second end of the adjusting member 400. Two positioning blocks 446 are disposed in the receiving chamber 442, and the two positioning blocks 446 are disposed opposite to each other on two sides of the second end of the adjusting member 400. The second elastic element 1200 roughly has a U-shaped structure, and the two ends of the second elastic element 1200 are respectively hooked on the two positioning blocks 446. A connecting protrusion 1220 is disposed in the middle of the second elastic element 1200. The second elastic element 1200 may be spherical, and the second elastic element 1200 may be movably inserted into the second connection groove 480. In some embodiments, the second connection groove 480 may also be opened or defined on the operation part 440, and the second elastic element 1200 may be connected to the second end of the adjusting member 400 and may be movably inserted into the second connection groove 480 of the operation part 440, which may also achieve the above technical effects.

The adjusting member 400 of the present disclosure avoids the clamping space S, which means that the adjusting member 400 of the present disclosure has no part disposed between the first socket module 100 and the second socket module 200, so as to prevent the adjusting member 400 from interfering with the abutment of the second socket module 200 against the panel 500.

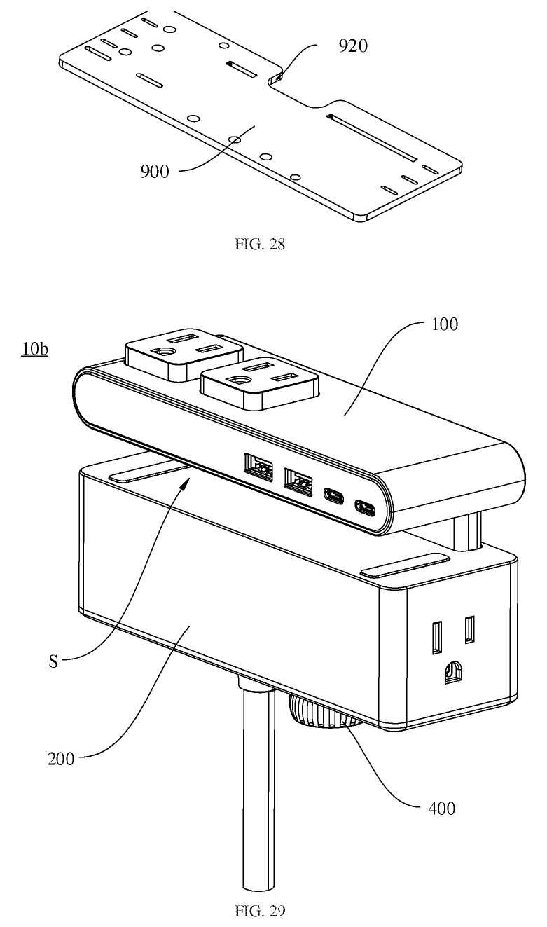

FIG. 28 is a structural schematic view of a circuit board. In some embodiments, components for realizing the functions of the socket device 10, such as the circuit board 900, may be disposed in the first socket housing 12 and the second socket housing 32. The circuit board 900 is configured to electrically connect with each power supply interface 120, serving functions such as control, current distribution, etc. In order to avoid interference of the circuit board 900 with the lifting and lowering of the adjusting member 400, the circuit board 900 may be provided with an avoidance part 920, and the avoidance part 920 may have a hole-shaped structure or a groove-shaped structure. The adjusting member 400 may pass through the avoidance part 920 with a clearance, enabling the adjusting member 400 to lift and lower normally.

In summary, in the socket device 10a of the present disclosure, by only rotating the adjusting member 400, the second socket module 200 may approach or move away from the first socket module 100, so as to adjust the distance between the first socket module 100 and the second socket module 200, facilitating the assembly of the socket device 10 onto the panel 500 with different specifications and thicknesses. The socket device 10a may be assembled onto the panel 500 without the need for tools, thus the socket device 10a has good flexibility and convenience in disassembly and assembly.

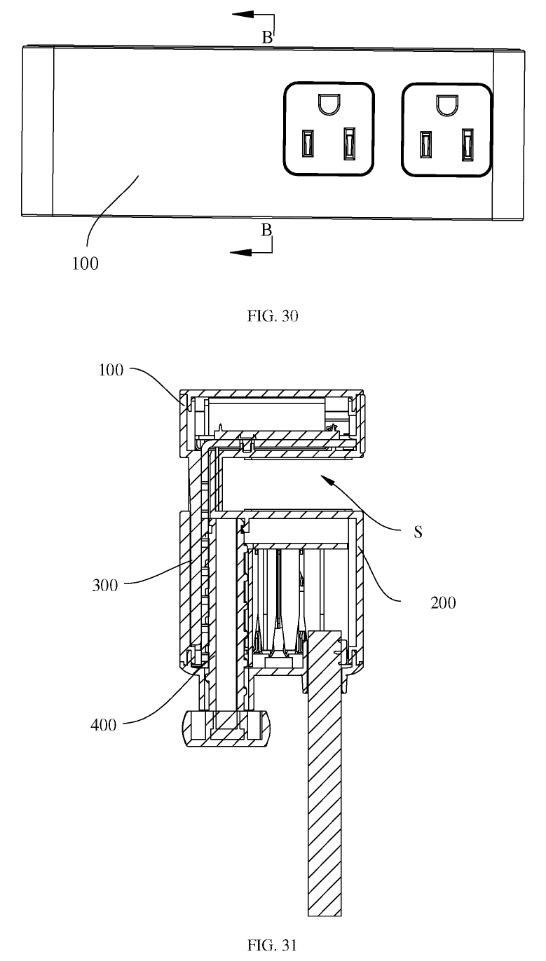

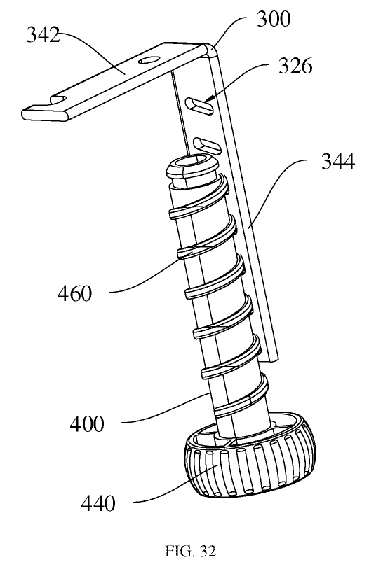

Based on the same design concept, the present disclosure further provides a socket device 10b. FIG. 29 is a structural schematic view of the socket device 10b, FIG. 30 is a top structural schematic view of the socket device 10b of FIGS. 29, and FIG. 31 is a cross-sectional structural schematic view of the socket device 10b of FIG. 30 in a B-B direction. Referring to FIGS. 29 to 31, similar to the socket device 10a mentioned above, the socket device 10b also includes the first socket module 100, the second socket module 200, the connection member 300, and the adjusting member 400. Unless otherwise specified, the structure and the function of these components in the socket device 10b are roughly the same as those in the socket device 10a. Therefore, the corresponding descriptions in FIGS. 1 to 21 may be referred to, which is not repeated in the present disclosure.

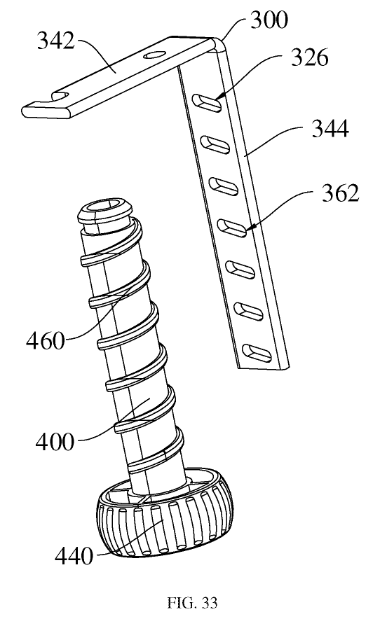

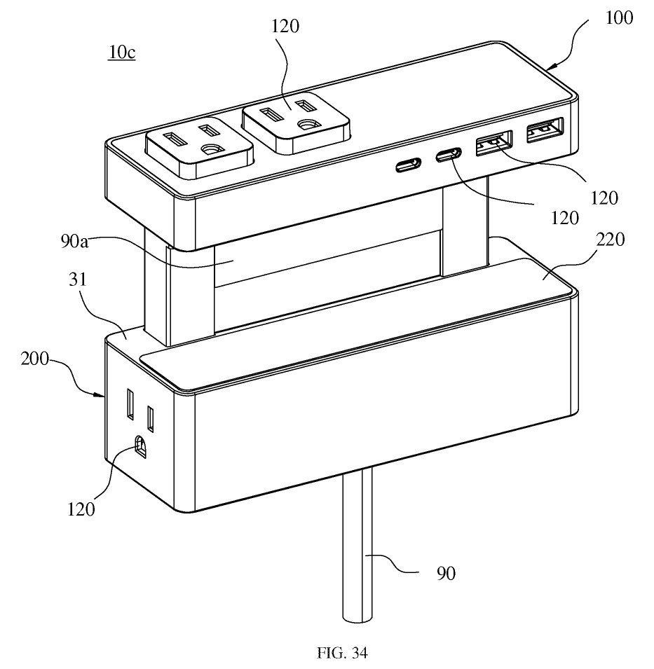

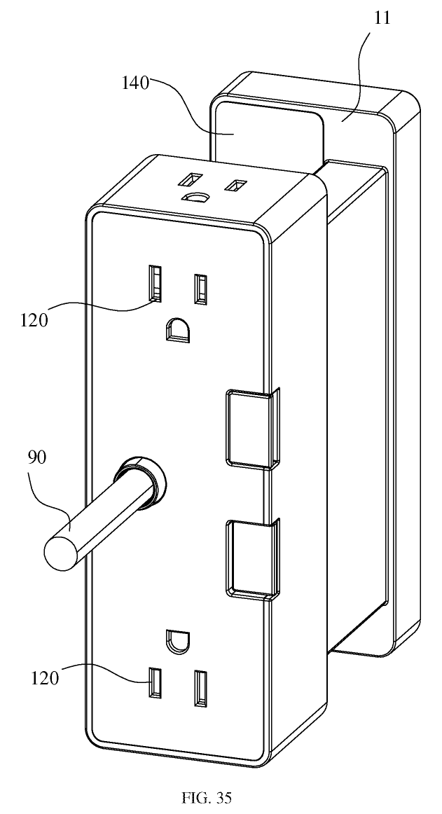

FIG. 32 is a structural schematic view illustrating assembly of the connection member 300 with the adjusting member 400 of the socket device 10b, and FIG. 33 is an exploded structural schematic view of a structure of FIG. 32. Referring to FIG. 32 and FIG. 33, unlike socket device 10a, the connection member 300 of socket device 10b defines multiple adjusting holes 326, and the adjusting holes 326 are arranged in sequence along the direction (i.e., the first direction) from the first socket module 100 to the second socket module 200. At least a part of the peripheral surface of the adjusting member 400 is provided with the threads 460, and the threads 460 are adaptively engaged in at least a part of the adjusting holes 326.

In the socket device 10b of the present disclosure, the multiple adjusting holes 326 are defined on the connection member 300, and the multiple adjusting holes 326 are arranged in sequence along the direction from the first socket module 100 to the second socket module 200. At least a part of the peripheral surface of the adjusting member 400 is provided with the threads 460, and the threads 460 are adaptively engaged in at least a part of the adjusting holes 326. Therefore, by rotating the adjusting member 400, the threads 460 on the adjusting member 400 can step through the multiple adjusting holes 326, thereby driving the adjusting member 400 to approach or move away from the first socket module 100. Since the adjusting member 400 is rotatably connected to the second socket module 200, the adjusting member 400 and the second socket module 200 can synchronously approach or move away from the first socket module 100 during the rotation of the adjusting member 400. Therefore, the distance between the first socket module 100 and the second socket module 200 can be adjusted, thereby enabling the socket device 10 to be adaptively assembled on panels 500 with different specifications and thicknesses. The distance between the first socket module 100 and the second socket module 200 may be adjusted only by rotating the adjusting member 400. Therefore, the socket device 10b has good flexibility and convenience in disassembly and assembly. The specific details of the socket device 10a may be further described below with reference to the accompanying drawings.

In some embodiments, the connection member 300 includes a part that is disposed along the direction from the first socket module 100 to the second socket module 200. That is, the connection member 300 has the part that is disposed vertically (disposed along the first direction), and this part may be the joining section 344 of the socket device 10a. The difference is that the joining section 344 of the socket device 10a does not define the adjusting hole 326, while the joining section 344 of the socket device 10b defines multiple adjusting holes 326, and a distance between adjacent adjusting holes 326 is consistent with a pitch of the threads 460 on the adjusting member 400. Therefore, during the rotation of the adjusting member 400, the threads 460 on the adjusting member 400 may step through the multiple adjusting holes 326, thereby driving the adjusting member 400 to approach or move away from the first socket module 100. In some embodiments, the joining section 344 of the socket device 10a may also define the adjusting holes 326, and the support part 320 of the socket device 10b may also have a certain inclination angle.

In some embodiments, the connection member 300 has a part that extends along the first direction and enters the interior of the second socket module 200. That is, the joining section 344 of the socket device 10a has a part inserted into the interior of the second socket module 200. The part of the connection member 300 that is disposed in the interior of the second socket module 200 defines the multiple adjusting holes 326. In this way, the part of the connection member 300 that defines the adjusting holes 326 and at least a part of the connected adjusting member 400 are both disposed in the interior of the second socket module 200, so that the support part 320 and the adjusting member 400 are hidden by the second socket module 200, thereby improving the aesthetic appearance of the product.

Referring to FIGS. 32 and 33, the adjusting member 400 steps through the adjusting holes 326 of the joining section 344 and the adjusting member 400 may be supported by the joining section 344. Therefore, the rotation of the adjusting member 400 does not require the support part 320. Therefore, in the connection member 300 of the socket device 10b, the support part 320 may be omitted.

In summary, in the socket device 10b of the present disclosure, by only rotating the adjusting member 400, the second socket module 200 may approach or move away from the first socket module 100. Therefore, the distance between the first socket module 100 and the second socket module 200 may be adjusted, facilitating the assembly of the socket device 10 onto the panels 500 with different specifications and thicknesses. The socket device 10b may be assembled onto the panel 500 without the need for tools. Therefore, the socket device 10b has good flexibility and convenience in disassembly and assembly.

In some embodiments, during the socket device 10 assembled onto the panel 500, the first socket module 100 may first be disposed on the top surface of the panel 500. The adjusting member 400 is then rotated, so that the adjusting member 400 and the second socket module 200 may move toward the first socket module 100 until the second socket module 200 abuts against the bottom surface of the panel 500. The self-locking of the adjusting member 400 and the connection member 300 may be configured to fix the second socket module 200 relative to the panel 500, so that the socket device 10 may be stably assembled onto the panel 500. In some embodiments, the second socket module 200 is first disposed on the bottom surface of the panel 500. The adjusting member 400 is then rotated, so that the connection member 300 and the first socket module 100 move toward the second socket module 200 until the first socket module 100 abuts against the top surface of the panel 500. The self-locking of the adjusting member 400 and the connection member 300 is configured to fix the first socket module 100 relative to the panel 500, so that the socket device 10b is stably assembled onto the panel 500.

In some embodiments, the connection member 300 and the adjusting member 400 may also adopt a gear-and-rack connection form. In some embodiments, the connection member 300 is connected to the first socket module 100, the connection member 300 is in a rack structure form, and the connection member 300 extends along the first direction. The adjusting member 400 is rotatably connected to the second socket module 200, and the adjusting member 400 is in a gear structure form. A central axis of the adjusting member 400 may be perpendicular to the first direction, and the adjusting member 400 may mesh with the connection member 300. In some embodiments, the central axis of the adjusting member 400 may be set along the first direction, and the adjusting member 400 is in transmission connection with the connection member 300 through an intermediate gear. The adjusting member 400 has a part protruding from a side surface of the second socket module 200. In this way, the user may operate the part of the adjusting member 400 protruding from the second socket module 200, causing the adjusting member 400 to rotate. The adjusting member 400 meshes with the connection member 300, driving the adjusting member 400 and the connection member 300 to move relative to each other, thereby driving the second socket module 200 and the first socket module 100 to move relative to each other in the first direction. Therefore, the size of the clamping space S in the first direction is adjusted, and the distance between the first socket module 100 and the second socket module 200 is adjusted, thereby enabling the socket device 10 to be adaptively assembled onto the panels 500 with different specifications and thicknesses.

Based on the same design concept, the present disclosure further provides a socket device 10c, and FIG. 34 is a structural schematic view of the socket device 10c. Similar to the socket device 10a mentioned above, the socket device 10c also includes the first socket module 100, the second socket module 200, and the connection member 300. Unless otherwise specified, the structure and the function of these components in the socket device 10c are roughly the same as those in the socket device 10a. Therefore, the corresponding descriptions in FIGS. 1 to 21 may be referred to, which is not repeated in the present disclosure.

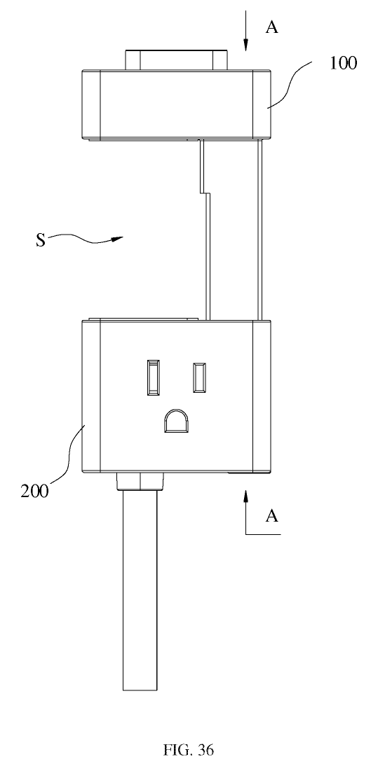

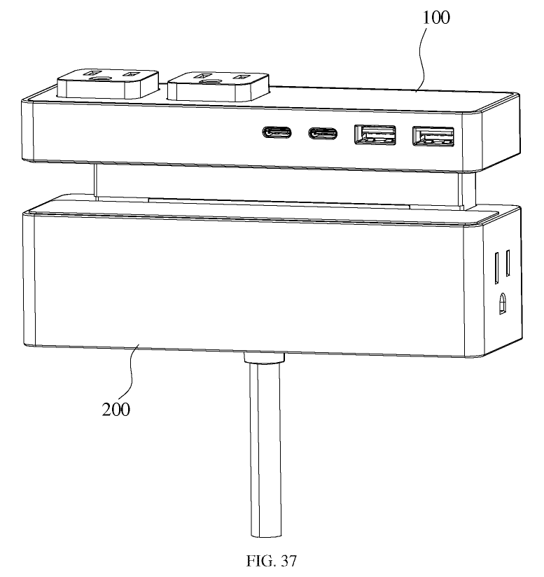

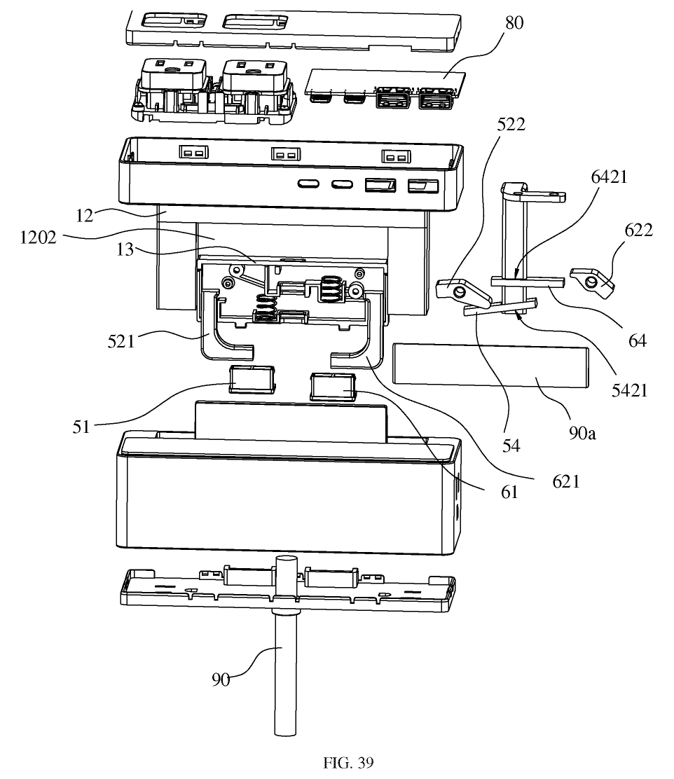

FIGS. 35 to 40 show structural schematic view illustrating assembly of various structures of the socket device 10c. Unlike the socket device 10a, the adjusting member 400 is not disposed in the socket device 10c. That is, in the socket device 10c, there is no adjusting member 400 that is configured to cooperate with the connection member 300 to adjust the size of the clamping space S in the first direction.

Referring to FIGS. 34 to 40, the socket device 10c includes the first socket module 100, the connection member 300, the second socket module 200, and a locking mechanism 50. The first socket module 100 is connected to the second socket module 200 through the connection member 300 to form an integrated unit, forming a main structure of the socket device 10c. Both the first socket module 100 and the second socket module 200 have the ability to provide plug-in power supply services to electrical devices.

In this embodiment, the connection member 300 may be configured as a linkage rod (or simply a rod). An end of the connection member 300 is fixedly disposed on the first socket module 100, and the second socket module 200 is movably installed to another end of the connection member 300. The second socket module 200 cooperates with the first socket module 100 to form the clamping space S.

The locking mechanism 50 is movably disposed on the second socket module 200. In some embodiments, the locking mechanism 50 is movably disposed on a bracket 13 of the second socket module 200. The locking mechanism 50 has a locked state for locking the connection member 300 and an unlocked state for releasing the connection member 300. In a case where the locking mechanism 50 is in the locked state, the second socket module 200 and the first socket module 100 are locked by the locking mechanism 50 and remain relatively stationary. In a case where the locking mechanism 50 is the unlocked state, the second socket module 200 may approach or move away from the first socket module 100, so that the width of the clamping space S is able to be adjusted.

In a case where the locking mechanism 50 of the socket device 10c is in the unlocked state, a relative distance between the second socket module 200 and the first socket module 100 may be manually adjusted, so as to adjust the width of the clamping space S. In some embodiments, the socket device 10c may further include a driving mechanism 60, and the driving mechanism 60 cooperates with the locking mechanism 50 to adjust the relative distance between the second socket module 200 and the first socket module 100, facilitating operation.

The driving mechanism 60 is movably disposed on the second socket module 200, and the driving mechanism 60 is in transmission connection with the connection member 300. In some embodiments, the driving mechanism 60 is movably disposed on the bracket 13 of the second socket module 200. The driving mechanism 60 has a non-operating state and an operating state. In a case where the driving mechanism 60 is in the non-operating state, the driving mechanism 60 is in a clearance-fit with the connection member 300. In a case where the driving mechanism 60 is in the operating state, the driving mechanism 60 is configured to drive the connection member 300 to move relative to the second socket module 200. Therefore, the second socket module 200 moves close to the first socket module 100, so that the socket device 10c achieves clamping and fixing.

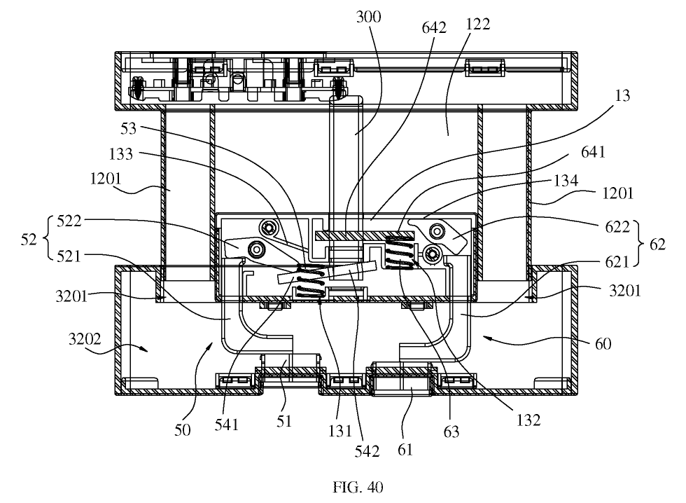

The locking mechanism 50 and the driving mechanism 60 are disposed on two sides of the connection member 300, respectively (for example, from the perspective of FIG. 40, the locking mechanism 50 and the driving mechanism 60 are disposed on a left side and a right side of the connection member 300, respectively). In this way, a sufficient safety distance is maintained between the locking mechanism 50 and the driving mechanism 60, so as to avoid interference during their operation.

The socket device 10c of the present embodiment is a socket product that is suitable for installing on the panel 500. The socket device 10c is configured to clamp and be disposed on an edge of panel 500 during use, which is convenient to use without occupying the space of the desktop. In some embodiments, in the socket device 10c, the first socket module 100, the connection member 300, and the second socket module 200 are assembled to form the main structure. The first socket module 100 and the second socket module 200 cooperate to form the clamping space S, and the clamping space S is configured to accommodate the edge of the panel 500, so as to achieve the installation of the socket device 10c. During installation, the locking mechanism 50 is operated to unlock and release the connection member 300. According to the thickness of the edge of the panel 500, the first socket module 100 and the second socket module 200 are operated to move close to or away from each other. The width of the clamping space S is adjusted to match the thickness of the edge of the desktop panel, so that the edge of the desktop panel may be smoothly inserted into the clamping space S. Therefore, pre-positioning of the socket device 10c is completed. Next, the driving mechanism 60 is operated, and the driving mechanism 60 is able to drive the connection member 300 to move relative to the second socket module 200. Therefore, the second socket module 200 is driven to move toward the first socket module 100, making the first socket module 100 and the second socket module 200 more tightly clamp the edge of the desktop panel, thereby achieving the clamping and fixing of the socket device 10c. The installation method is simple and does not require assistance of special tools.

In a case where it is necessary to adjust an installation position of the socket device 10c on the desktop panel, the locking mechanism 50 is repeatedly operated, so that the first socket module 100 and the second socket module 200 unlock and move away from each other. Therefore, the socket device 10c may move. After adjusting the socket device 10c to a new installation position, the driving mechanism 60 is operated again, so that the edge of the desktop panel is clamped between the first socket module 100 and the second socket module 200. The adjustment of the installation position is convenient, labor-saving, efficient, and highly flexible, which helps to improve the user experience.

In many situations, in a case where the socket device 10c clamps the edge of the desktop panel, the first socket module 100 and the second socket module 200 may be pulled far apart, so that the width of the clamping space S is much greater than the thickness of the edge of the desktop panel. A single operation of the driving mechanism 60 may not be enough to completely close the first socket module 100 and the second socket module 200 together to clamp and fix the edge of the desktop panel in one go. In this case, the driving mechanism 60 may be operated continuously for multiple times (or repeatedly), so that the first socket module 100 is gradually and continuously close to the second socket module 200 until the edge of the desktop panel is firmly clamped.

The first socket housing 12 is provided with a guiding pillar 1201 and a connection plate 1202, and the connection plate 1202 is connected to the guiding pillar 1201. Specifically, in the present embodiment, the guiding pillar 1201 is configured as a movable guiding pillar connected to the connection plate 1202. The second socket housing 32 defines an accommodating chamber 3202 and a guiding hole 3201. At least a part of the first socket housing 12 is extendable and movable in the accommodating chamber 3202, and the guiding pillar 1201 is slidably inserted into the guiding hole 3201. During the driving mechanism 60 being operated to drive the connection member 300 and the first socket module 100 to move close to the second socket module 200, the guiding pillar 1201 slides in the guiding hole 3201, playing a guiding and limiting role, thereby improving stability of the relative movement between the first socket module 100 and the second socket module 200.

In some embodiments, referring to FIG. 40, the second socket module 200 further includes the bracket 13, and the bracket 13 is disposed on the second socket housing 32. The installation method may include at least one of a screw connection, a snap-fit connection, or bonding, etc. This installation method may be flexibly selected according to actual needs.

The bracket 13 is mainly configured to load and support the locking mechanism 50 and the driving mechanism 60.

The locking mechanism 50 includes a lock button 51, a lock transmission assembly 52, a first elastic member 53, and a lock body 54. The lock button 51 is movably disposed on the second socket housing 32, the lock transmission assembly 52 is movably disposed on the bracket 13, and the lock transmission assembly 52 is in transmission connection with the lock button 51. The first elastic member 53 is disposed on the bracket 13. The lock body 54 has a contact end 541 and a locking end 542 opposite to each other. The contact end 541 is in contact with or abuts against the first elastic member 53, and the locking end 542 is in a locking-fit or an unlocking-fit with the connection member 300.

In practical use, in a case where the lock button 51 is not pressed, the first elastic member 53 applies the elastic thrust to the lock body 54, so that the locking end 542 locks the connection member 300, and the locking mechanism 50 is in the locked state. In this case, the first socket module 100 and the second socket module 200 may be unable or difficult to move relative to each other.

In the present disclosure, two guiding pillars 1201 are disposed and two guiding holes 3201 are defined, and the two guiding pillars 1201 and the two guiding holes 3201 are in a one-to-one correspondence. The connection plate 1202 is disposed between two guiding pillars 1201, so as to improve structural integrity and strength of the two guiding pillars 1201. The bracket 13 is disposed between the two guiding pillars 1201.

During installing the first socket module 100 and the second socket module 200, the guiding pillar 1201 and the connection plate 1202 are inserted into the accommodating chamber 3202, so that the first socket module 100 and the second socket module 200 fit together to form a U-shaped structure. In a case where the socket device 10c horizontally is moved and the edge of the desktop is inserted into the socket device 10c, the guiding pillar 1201 and the connection plate 1202 may abut against a side surface of the desktop panel, thereby forming an installation positioning effect.

In some embodiments, a blocking plate 90a is further connected between the two guiding pillars 1201. The blocking plate 90a is configured to block the connection member 300, so as to prevent the connection member 300 from being exposed and affecting the appearance in a case where the first socket module 100 and the second socket module 200 are pulled away from each other. Moreover, the connection strength between the two guiding pillars 1201 is further strengthened.

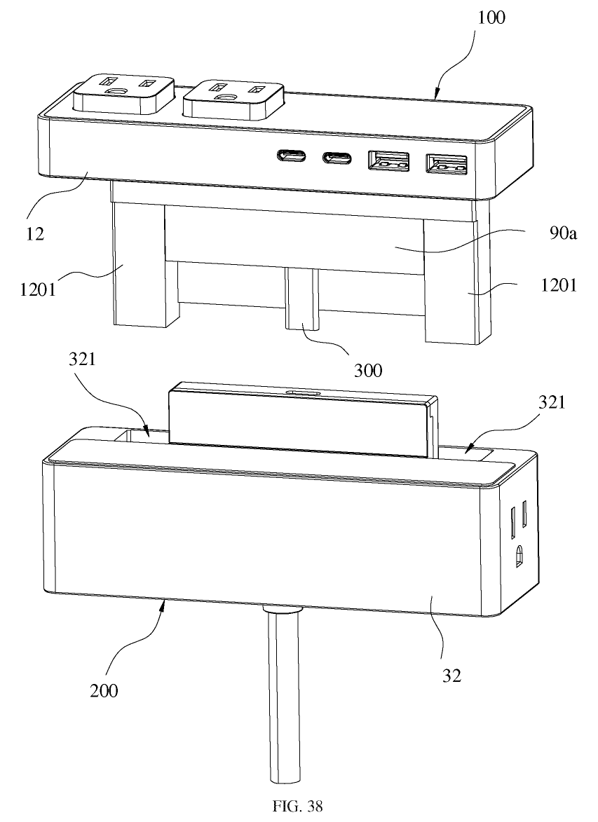

Referring to FIG. 37, in some embodiments, in a case where the socket device 10c is in a collapsed or stowed state, the first socket module 100 and the second socket module 200 may be adjusted to a minimum separation distance, making an overall structure of the socket device 10c more compact and smaller in volume, occupying smaller installation space, and more conducive to storage and portability. In this case, due to the locking mechanism 50 locking the connection member 300, the first socket module 100 and the second socket module 200 cannot loosen or separate, that is, the locking end 542 achieves the locking-fit with the connection member 300.

Referring to FIGS. 39 to 40, in a case where the lock button 51 is pressed, the lock button 51 pushes the lock transmission assembly 52 to move, causing the lock transmission assembly 52 to synchronously press the contact end 541, causing the lock body 54 to rotate. The contact end 541 compresses the first elastic member 53 to store energy, while simultaneously driving the locking end 542 to move and disengage from the connection member 300, achieving unlocking and releasing of the connection member 300. That is, the locking end 542 achieves the unlocking-fit with the connection member 300. In this case, the first socket module 100 obtains the freedom to move telescopically relative to the second socket module 200, making it convenient to adjust the width of the clamping space S to adapt to the desktop panel with different thicknesses, thereby improving applicability of the socket device 10c.

In some embodiments, referring to FIG. 39 to 40, the locking end 542 defines a lock hole 5421, and the connection member 300 is inserted into the lock hole 5421. In a case where the locking mechanism 50 is in the locked state, the first elastic member 53 is in contact with or abuts against the contact end 541 to tilt the lock body 54. A hole wall of the lock hole 5421 is in a press-fit with the connection member 300, so that the connection member 300 is locked by the lock body 54. In a case where the lock button 51 is pressed to switch the locking mechanism 50 from the locked state to the unlocked state, the lock transmission assembly 52 drives the contact end 541 to rotate and compress the first elastic member 53, and a hole wall of the lock hole 5421 is in clearance-fit with the connection member 300, so that the lock body 54 releases the connection member 300. The locking and unlocking methods in the present embodiment have simple principles, high reliability, and may achieve stepless locking, greatly expanding types and ranges of the desktop panels suitable for clamping installation.

In some embodiments, the first elastic member 53 may be, but is not limited to, the spring.

Referring to FIG. 40, based on the above embodiments, the bracket 13 defines a first installation groove 131, and the first elastic member 53 is disposed in the first installation groove 131. The first installation groove 131 is configured to accommodate and position the first elastic member 53, ensuring stable and reliable expansion and contraction deformation of the first elastic member 53.

In some embodiments, the bracket 13 defines the first installation groove 131, and the first installation groove 131 is coaxially arranged with the connection member 300. The first elastic member 53 is disposed in the first mounting groove 131, and the first elastic member 53 may be sleeved onto or separated from the connection member 300. The difference between the present embodiment and the above embodiments is only that an arrangement position of the first elastic member 53 may be adjusted, but it may achieve the same technical effects as the above embodiments, which is not repeated here.

Referring to FIGS. 39 to 40, in an embodiment, the lock transmission assembly 52 includes a lock push-up block 521 and a lock shift-block 522. The lock push-up block 521 is slidably disposed on the bracket 13, and an end of the lock push-up block 521 is in transmission connection with the lock button 51. The lock shift-block 522 is rotatably disposed on the bracket 13, and an end of the lock shift-block 522 is in transmission connection with another end of the lock push-up block 521. Another end of the lock shift-block 522 is in transmission cooperation with the locking end 542. A driving force output by the lock button 51 may be transmitted to the lock body 54 more efficiently through the lock push-up block 521 and the lock shift-block 522, improving unlocking efficiency while having fewer cooperating components, high transmission reliability, and good durability.

In some embodiments, as shown in FIG. 40, based on the above embodiments, the bracket 13 is provided with a first limit part 133, and the first limit part 133 is disposed on a side of the connection member 300 facing the locking mechanism 50. In a case where the locking mechanism 50 is in the locked state, the first limit part 133 is in contact with or abuts against the lock shift-block 522. In a case where the locking mechanism 50 is in the locked state, the first elastic member 53 applies the elastic force to the lock body 54, and the lock body 54 tightly presses the lock shift-block 522 against the first limit part 133. In this case, the first limit part 133 plays a limiting and supporting role for the lock shift-block 522.

In an embodiment, the driving mechanism 60 includes a driving button 61, a driving assembly 62, a second elastic member 63, and a driving body 64. The driving button 61 is movably disposed in the second socket housing 32. The driving assembly 62 is movably disposed on the bracket 13, and the driving assembly 62 is in transmission connection with the driving button 61. The second elastic member 63 is disposed on the bracket 13. The driving body 64 has a transmission end 641 and a driving end 642 opposite to each other. The transmission end 641 is in contact with or abuts against the second elastic member 63, and the driving end 642 is in an abutting-fit or the clearance-fit with the connection member 300.

In some embodiments, the driving end 642 defines a fitting hole 6421, and the connection member 300 is inserted into the fitting hole 6421. In a case where the driving mechanism 60 is in the non-operating state, the second elastic member 63 is in contact with or abuts against the transmission end 641, so that the driving body 64 is kept in an avoidance position. In this case, a hole wall of the fitting hole 6421 is in clearance-fit with the connection member 300, thereby preventing the driving end 642 from interfering with the movement of the connection member 300.

In a case where the driving button 61 is pressed to switch the driving mechanism 60 from the non-operating state to the operating state, the driving assembly 62 drives the transmission end 641 to rotate and compress the second elastic member 63. At the same time, the driving body 64 tilts, causing the hole wall of the fitting hole 6421 to be in the press-fit with the connection member 300, so that the driving end 642 drives the connection member 300 to move relative to the second socket module 200. The driving end 642 is in contact with or abuts against the connection member 300, causing the first socket module 100 and the second socket module 200 to move close to each other, thereby achieving clamping and fixing of the socket device 10c onto the edge of the desktop panel.

In the non-operating state, the hole wall of the fitting hole 6421 is not in contact with the connection member 300. On the one hand, after the locking mechanism 50 is unlocked, during the first socket module 100 and the second socket module 200 moving close to or away from each other, the driving body 64 may not interfere with the movement of the connection member 300. On the other hand, it is also not easy to accidentally trigger the driving mechanism 60, thereby preventing unintended movements of the first socket module 100 and the second socket module 200.

After the socket device 10c is installed on the edge of the desktop panel, the driving button 61 is pressed, so that the driving button 61 drives the driving assembly 62 to move. The driving assembly 62 then synchronously presses the transmission end 641, causing the driving body 64 to move relative to the second socket module 200 (specifically, the bracket 13). That is, the driving body 64 moves downward toward the second socket module 200. On the one hand, the hole wall of the fitting hole 6421 is in the press-fit with the connection member 300, forming a locking relationship between the driving body 64 and the connection member 300. On this basis, the downward movement of the driving body 64 may synchronously pull the connection member 300 and the first socket module 100 to move downward together, so that the first socket module 100 and the second socket module 200 move close to each other and clamp the desktop panel, thereby improving the firmness of clamping and installation of the socket device 10c.

Referring to FIGS. 39 to 40, in an embodiment, the driving assembly 62 includes a driving push-up block 621 and a driving shift-block 622. The driving push-up block 621 is slidably disposed on the bracket 13, and an end of the driving push-up block 621 is in transmission connection with the driving button 61. The driving shift-block 622 is rotatably disposed on the bracket 13, and an end of the driving shift-block 622 is in transmission connection with another end of the driving push-up block 621. Another end of the driving shift-block 622 is in transmission cooperation with the transmission end 641. The driving force output by the driving button 61 may be transmitted to the driving body 64 more efficiently through the driving push-up block 621 and the driving shift-block 622, improving driving efficiency. Moreover, the driving assembly 62 has fewer cooperating components, high transmission reliability, and good durability.

In some embodiments, as shown in FIG. 40, based on the above embodiments, the bracket 13 is also provided with a second limit part 134, and the second limit part 134 is disposed on a side of the connection member 300 facing the driving mechanism 60. In a case where the driving mechanism 60 is in the non-operating state, the driving shift-block 622 is in contact with or abuts against the second limit part 134.

In a case where the driving mechanism 60 is in the non-operating state, the second elastic member 63 applies the elastic thrust to the driving body 64, causing the driving body 64 to press the driving shift-block 622 against the second limit part 134. In this case, the second limit part 134 plays a role in limiting and supporting the driving shift-block 622, ensuring structural stability.

In some embodiments, the second elastic member 63 may be, but is not limited to, the spring.

On the basis of the above embodiments, the bracket 13 also defines a second installation groove 132, and the second elastic member 63 is disposed in the second installation groove 132. The second installation groove 132 is configured to accommodate and position the second elastic member 63, ensuring stable and reliable expansion and contraction deformation of the second elastic member 63.

By continuously pressing the driving button 61, the first socket module 100 and the second socket module 200 may gradually move close to each other, ultimately achieving clamping and fixing of the first socket module 100 and the second socket module 200 onto the edge of the desktop panel, thereby completing clamping installation of the socket device 10c onto the desktop panel.

In the socket device of the embodiments of the present disclosure, the relative position of the first socket module and the second socket module of the socket device is adjustable, and the clamping space is defined between the first socket module and the second socket module, so that the first socket module and the second socket module are able to directly clamp opposite sides of an external structure. This limits a position of the socket device relative to the external structure and prevents the socket device from being easily displaced by an external force. Moreover, the first socket module and the second socket module may be respectively provided with power supply interfaces that are connected to external electrical structures, thereby avoiding concentration of multiple power supply interfaces on a single socket module. Therefore, the first socket module and the second socket module occupy a smaller area on a surface of the external structure, and the socket device is more convenient to use.

The same or similar reference numbers in the accompanying drawings of the present disclosure correspond to the same or similar components. In the description of the present disclosure, if there are terms, such as “up”, “down”, “left”, “right” or the like, indicating directions or positional relationships, the terms are based on the methods or positional relationships shown in the accompanying drawings. It is only intended to facilitate the description of the embodiments of the present disclosure and simplify the description, but does not indicate or imply that the device or the element referred to must have a specific orientation, be constructed and operated in a specific orientation. Therefore, the terms describing positional relationships in the accompanying drawings are configured for exemplary description only and cannot be understood as limiting the present disclosure. For those of ordinary skill in the art, specific meanings of the above terms may be understood according to specific situations.

The above description presents only the preferred embodiments of the present disclosure and is not intended to limit the present disclosure. Any modifications, equivalent substitutions, and improvements made within spirit and principles of the present disclosure should be included within the protection scope of the present disclosure.

1. A socket device, comprising:
a first socket module;
a second socket module, disposed opposite to the first socket module in a first direction, wherein a clamping space is defined between the second socket module and the first socket module, and at least one selected from the group consisting of the first socket module and the second socket module is provided with a power supply interface; and
a connection member, fixedly connected to the first socket module and movably connected to the second socket module, so that a relative position of the second socket module and the first socket module in the first direction is adjustable, and a size of the clamping space in the first direction is adjustable.

2. The socket device according to claim 1, wherein the socket device further comprises an adjusting member rotatably connected to the second socket module, and the adjusting member avoids the clamping space and is connected to the connection member; and during the adjusting member rotating around its own axis, the adjusting member and the connection member are able to move relative to each other, so as to drive the second socket module and the first socket module to move relative to each other in the first direction.

3. The socket device according to claim 2, wherein the connection member comprises a pulling plate and a support part, an end of the pulling plate is connected to the first socket module, another end of the pulling plate is connected to the support part, and the adjusting member is able to pass through the support part via a threaded engagement.

4. The socket device according to claim 3, wherein the support part is disposed outside the first socket module, and the support part is disposed on a side of the first socket module facing the second socket module.

5. The socket device according to claim 4, wherein at least a part of the adjusting member and the support part are both disposed inside the second socket module.

6. The socket device according to claim 2, wherein a plurality of adjusting holes are defined on the connection member, and the plurality of adjusting holes are arranged in sequence along the first direction; and
at least a part of a peripheral surface of the adjusting member is provided with threads, and the threads are adaptively engaged in at least a part of the plurality of adjusting holes.

7. The socket device according to claim 6, wherein the connection member comprises a part that extends along the first direction and enters an interior of the second socket module, and the part of the connection member that is disposed in the interior of the second socket module defines the plurality of adjusting holes.

8. The socket device according to claim 2, wherein the second socket module defines a snap-fit groove, and a first end of the adjusting member is rotatably connected to the snap-fit groove.

9. The socket device according to claim 2, wherein the second socket module defines a through hole, and a side wall of the through hole defines a plurality of first positioning grooves that are spaced apart, and the plurality of first positioning grooves are disposed circumferentially around the through hole;
the adjusting member is able to movably pass through the through hole, and a first connection groove is defined on a peripheral surface of the adjusting member; and
the socket device further comprises a positioning member and a first elastic element; the positioning member comprises a first end and a second end, the first end of the positioning member is movably disposed in the first connection groove, and the second end of the positioning member is able to movably pass through the first connection groove and move into one of the plurality of first positioning grooves; and the first elastic element is disposed in the first connection groove and connected between the first end of the positioning member and an inner wall of the first connection groove.

10. The socket device according to claim 2, wherein a second end of the adjusting member is able to movably pass through the second socket module, and the second end of the adjusting member is provided with an operation part;
the socket device further comprises a second elastic element; and
one of the second end of the adjusting member and the operation part defines a second connection groove, and the second elastic element is connected to the other of the second end of the adjusting member and the operation part; and the second elastic element is able to be inserted into the second connection groove, and the second elastic element is able to be separated from the second connection groove.

11. The socket device according to claim 2, wherein the socket device further comprises:
a decorative member, connected to one of the first socket module and the second socket module; the decorative member defines a decorative chamber, and at least a part of the connection member is disposed in the decorative chamber; and the other of the first socket module and the second socket module defines a decorative groove, and at least a part of the decorative member is movably disposed in the decorative groove.

12. The socket device according to claim 11, wherein the socket device further comprises:
a first guiding part, connected to the first socket module; and
a second guiding part, connected to the second socket module, wherein the second guiding part is connected to the first guiding part via an insertion engagement.

13. The socket device according to claim 12, wherein the first guiding part is connected to a side surface of the first socket module facing the second socket module, and the second guiding part is connected to a side surface of the second socket module facing the first socket module; and at least one selected from the group consisting of at least a part of the first guiding part, at least a part of the second guiding part, and at least a part of the connection member is disposed in the decorative chamber.

14. The socket device according to claim 13, wherein the second guiding part is able to be movably inserted into the decorative chamber of the decorative member and disposed on an inner wall of the decorative member.

15. The socket device according to claim 1, wherein the socket device further comprises a locking mechanism, the locking mechanism is movably disposed on the second socket module, and the locking mechanism has a locked state for locking the connection member and an unlocked state for releasing the connection member; in a case where the locking mechanism is in the locked state, the second socket module and the first socket module are locked by the locking mechanism and remain relatively stationary; and in a case where the locking mechanism is the unlocked state, the second socket module is able to approach or move away from the first socket module, so that a width of the clamping space is able to be adjusted.

16. The socket device according to claim 15, wherein the socket device further comprises a driving mechanism, the driving mechanism is movably disposed on the second socket module, and the driving mechanism is in transmission connection with the connection member; the driving mechanism and the locking mechanism are disposed on two sides of the connection member, respectively; the driving mechanism has a non-operating state and an operating state; in a case where the driving mechanism is in the non-operating state, the driving mechanism is in a clearance-fit with the connection member; and in a case where the driving mechanism is in the operating state, the driving mechanism is configured to drive the connection member to move relative to the second socket module, so that the second socket module moves close to the first socket module.

17. The socket device according to claim 16, wherein
the second socket module comprises a bracket and a second socket housing, and the bracket is disposed on the second socket housing; and
the locking mechanism comprises a lock button, a lock transmission assembly, a first elastic member, and a lock body; the lock button is movably disposed on the second socket housing, the lock transmission assembly is movably disposed on the bracket, and the lock transmission assembly is in transmission connection with the lock button; the first elastic member is disposed on the bracket, the lock body comprises a contact end and a locking end opposite to each other, the contact end is able to abut against the first elastic member, and the locking end is able to be in a locking-fit or an unlocking-fit with the connection member.

18. The socket device according to claim 1, wherein the first socket module comprises a first socket housing, and an end of the connection member is fixedly connected to the first socket housing; and
the first socket housing is provided with a guiding pillar, the second socket module comprises a second socket housing, the second socket housing defines an accommodating chamber and a guiding hole, at least a part of the first socket housing is movable in the accommodating chamber, and the guiding pillar is slidably inserted into the guiding hole.

19. The socket device according to claim 1, wherein the first socket module comprises a first clamping surface facing the second socket module, the second socket module comprises a second clamping surface facing the first socket module, and the first clamping surface is spaced apart from the second clamping surface to form the clamping space.

20. The socket device according to claim 19, wherein the socket device further comprises:
a first anti-slipping member, disposed on the first clamping surface; and/or
a second anti-slipping member, disposed on the second clamping surface.
